(19) United States
(12) Patent Application Publication
(10) Pub. No.: US 2014/0330865 A1
(43) Pub. Date: Nov. 6, 2014

(54) METHOD AND APPARATUS FOR PROVIDING ADDRESS GEO-CODING

(71) Applicants: Wenwei Xue, Beijing, (CN); Zhanjiang Song, Beijing (CN); Yadong Sheng, Beijing (CN); Xiaojie Wang, Beijing (CN)

(72) Inventors: Wenwei Xue, Beijing, (CN); Zhanjiang Song, Beijing (CN); Yadong Sheng, Beijing (CN); Xiaojie Wang, Beijing (CN)

(73) Assignee: Nokia Corporation, Espoo (FI)

(21) Appl. No.: 14/360,647

(22) PCT Filed: Nov. 30, 2011
(86) PCT No.: PCT/CN2011/083257

§ 371 Date: May 26, 2014

(51) Int. Cl. G06F 17/30

(52) U.S. Cl. CPC G06F 17/30241
USPC 707/769

(57) ABSTRACT

An approach is provided for providing address geo-coding that enhances query result quality while increasing the flexibility of textual query strings. A geo-coding platform determines a request for geo-coding information, wherein the request is from a client to at least one geo-coding knowledge base and specifies at least one textual input. The geo-coding platform further causes, at least in part, a generation of at least one geo-coding request based, at least in part, on the at least one textual input. The geo-coding platform also determines to transmit the at least one geo-coding request to the at least one geo-coding knowledge base, one or more other geo-coding knowledge bases, or a combination thereof.

### BACKGROUND

Service providers and device manufacturers (e.g., wireless, cellular, etc.) are continually challenged to deliver value and convenience to consumers by, for example, providing compelling network services. One such service is providing geo-coding associated with map-based services. Geo-coding is the process of converting textual addresses into geographic coordinates that are used to place markers or positions on a map. For example, a user enters a textual query string of a location address in a search box of a map client user-interface, and a result list of zero to N location coordinates are returned and displayed with corresponding place markers on a rendering of a map. However, certain issues exist with such services. For example, the textual query string entered by users tends to be natural language oriented. Thus, the textual query string may not be formatted according to a format of the address used by geo-coding knowledge bases. Further, the textual query string may contain too detailed or fine-granular location information that may not be understandable by geo-coding knowledge bases. Additionally, map-based services may not be configurable and/or modifiable by the users of the service. Rather, the map-based services are often owned by third-party service providers and have an autonomous, black-box nature. Accordingly, service providers and device manufacturers face significant technical challenges in providing address geo-coding that accounts for the variability of textual query strings entered by users.

### SOME EXAMPLE EMBODIMENTS

Therefore, there is a need for an approach for providing address geo-coding that enhances query result quality while increasing the flexibility of textual query string inputs.

According to one embodiment, a method comprises determining a request for geo-coding information, wherein the request is from a client to at least one geo-coding knowledge base and specifies at least one textual input. The method also comprises causing, at least in part, a generation of at least one geo-coding request based, at least in part, on the at least one textual input. The method further comprises determining to transmit the at least one geo-coding request to the at least one geo-coding knowledge base, one or more other geo-coding knowledge bases, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determines a request for geo-coding information, wherein the request is from a client to at least one geo-coding knowledge base and specifies at least one textual input. The apparatus is also caused to generate at least one geo-coding request based, at least in part, on the at least one textual input. The apparatus is further caused to determine to transmit the at least one geo-coding request to the at least one geo-coding knowledge base, one or more other geo-coding knowledge bases, or a combination thereof.

According to another embodiment, a computer-readable storage medium carries one or more sequences of one or more instructions which, when executed by one or more processors, cause, at least in part, an apparatus to determine a request for geo-coding information, wherein the request is from a client to at least one geo-coding knowledge base and specifies at least one textual input. The apparatus is also caused to generate at least one geo-coding request based, at least in part, on the at least one textual input. The apparatus is further caused to determine to transmit the at least one geo-coding request to the at least one geo-coding knowledge base, one or more other geo-coding knowledge bases, or a combination thereof.

According to another embodiment, an apparatus comprises means for determining a request for geo-coding information, wherein the request is from a client to at least one geo-coding knowledge base and specifies at least one textual input. The apparatus also comprises means for causing, at least in part, a generation of at least one geo-coding request based, at least in part, on the at least one textual input. The apparatus further comprises means for determining to transmit the at least one geo-coding request to the at least one geo-coding knowledge base, one or more other geo-coding knowledge bases, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-15, 31-45 and 51-53.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing address geo-coding that enhances query result quality while increasing the flexibility of textual query strings, according to one embodiment;

FIG. 2 is a diagram of the components of a geo-coding platform and a word database, according to one embodiment;

FIG. 3 is a flowchart of a process for providing address geo-coding that enhances query result quality while increasing the flexibility of textual query string inputs, according to one embodiment;

FIG. 4 is a flowchart of an overview of a detailed process for providing address geo-coding that enhances query result quality while increasing the flexibility of textual query string inputs based on modified textual query strings, according to one embodiment;

FIG. 5 is a flowchart of a process for replacing synonyms in a textual query string, according to one embodiment;

FIG. 6 is a flowchart of a process for removing noise characters and/or words from a textual query string, according to one embodiment;

FIG. 7 is a flowchart of a process for removing flagged characters and/or words from a textual query string, according to one embodiment;

FIG. 8 is a flowchart of a process for determining similarity values for one or more results of a geo-coding request, according to one embodiment;

FIG. 9 is a flowchart of a process for determining a geo-coding knowledge base to transmit a geo-coding request to for generating one or more results, according to one embodiment;

FIG. 10 is a diagram of a user interface utilized in the processes of FIGS. 3-9, according to an embodiment;

FIG. 11 is a diagram of hardware that can be used to implement an embodiment of the invention;

FIG. 12 is a diagram of a chip set that can be used to implement an embodiment of the invention; and

FIG. 13 is a diagram of a mobile terminal (e.g., handset) that can be used to implement an embodiment of the invention.

### DESCRIPTION OF SOME EMBODIMENTS

Examples of a method, apparatus, and computer program for providing address geo-coding that enhances query result quality while increasing the flexibility of textual query strings are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

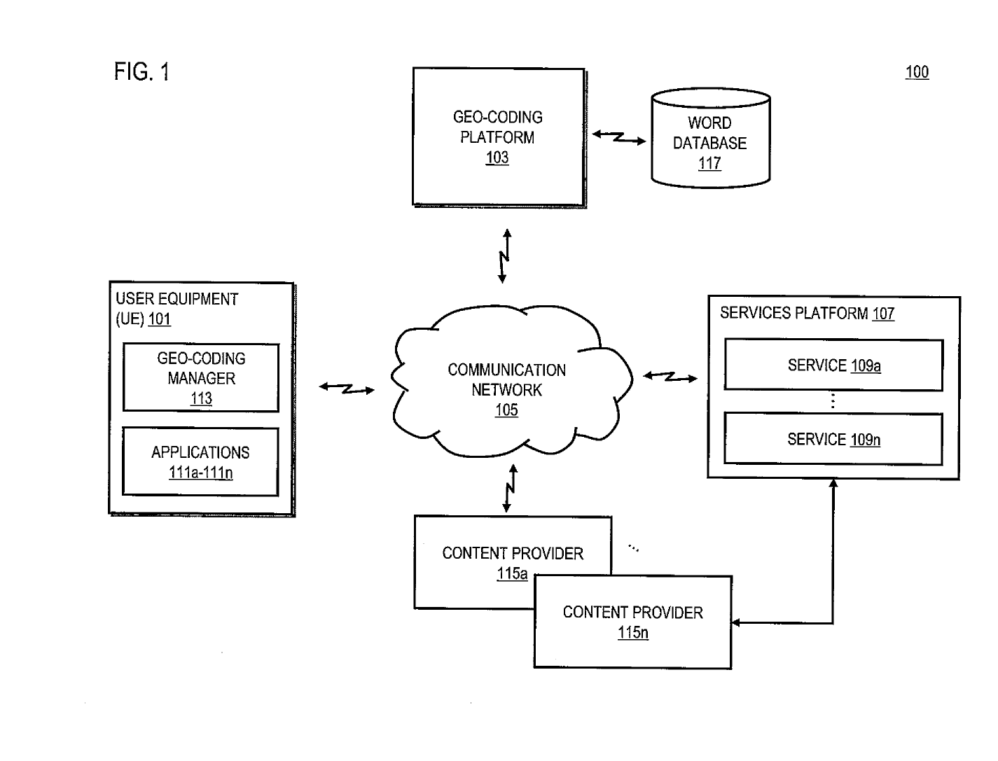

FIG. 1 is a diagram of a system capable of providing address geo-coding that enhances query result quality while increasing the flexibility of textual query strings, according to one embodiment. As discussed above, geo-coding services currently exist that allow a user to enter a textual query string of a location address in a search box of a map client user-interface. Additionally, geo-coding services currently exist that allow the receipt of an API request (e.g., RESTful API via HTTP) that contains a location address and other supplemental parameters from a client service, for example, a map client. The requests are then sent to one or more geo-coding knowledge bases where the requests are processed to determine set locations associated with the address. In response, a list of zero or more location coordinates are returned based on the requests and are displayed within a user-interface corresponding to one or more set points on a map. By way of example, a user may enter the textual query string of “1600 Amphitheater Parkway, Mountain View, Calif.” into an input box. In response, the query is sent to a geo-coding knowledge base where the textual query string is analyzed and converted into location coordinates. As a result, the GPS location of 37.423021 degrees latitude, −122.083739 longitude (corresponding to the textual query string) is designated on a map.

However, certain issues exist with such services. For example, users tend to enter the textual query string in a natural language format. The natural language format may result in some vagueness as a result of, for example, informal words being used in place of formal words that are customarily found in addresses. Additionally, for example, synonyms or translations of words may be used in the natural language textual query string that may add to the vagueness. Further, the natural language textual query string may not be formatted according to a standard address format. By way of example, the user may forget to enter the generic (e.g., street, road, court, place, etc.) portion of a street name, may use abbreviations, or otherwise incorrectly format the address. Thus, the textual query string may not be formatted according to a format required by the geo-coding knowledge base for returning results.

Further, the textual query string may contain too detailed or fine-granular location information that may not be understandable by a map-based service. For example, a user may enter a name of an individual that is associated with a specific address, may enter a unit number or a floor number, or may enter a neighborhood associated with a city. The geo-coding knowledge base may not recognize the name, unit number, floor number, or neighborhood associated with the city and return zero results. However, the user may rather obtain a coarse-granular result rather than no result at all (e.g., a city and state rather than no result when the user enters a neighborhood of the city in the textual query input). Related to this issue, the map-based service may not be configurable and/or modifiable by the users of the service. Rather, map-based services are often owned by third-party service providers and have an autonomous, black-box nature. Thus, various users cannot configure or modify the map-based services and the geo-coding knowledge bases according to the their preferences, such as returning a coarse-granular result rather than no result at all when too specific of a textual query string is entered.

To address these issues, a system 100 of FIG. 1 introduces the capability to provide address geo-coding that enhances query result quality while increasing the flexibility of textual query strings. The system 100 provides for multiple algorithmic components that parse and analyze textual query strings from a client device or backend service using natural language processing methods. The natural language processing methods allow for the noise word elimination, location entity extraction and semantic synonym translation over the textual query string, as well as the similarity measurement between the textual query string and one or more results from a geo-coding knowledge base. Based on the processing, the system 100 enhances query results and improves user experience by lowering failed queries (e.g., queries that have an empty result list) and eliminating incorrect results in the returned list. The system 100 also may identify and return a single most similar result as compared to the original textual query string to, for example, save the user the effort of determining the most accurate result.

As shown in FIG. 1, the system 100 comprises a user equipment (UE) 101 having connectivity to a geo-coding platform 103 via a communication network 105. The UE 101 may execute one or more applications 111a-111n (collectively referred to as applications 111). The applications 111 may include one or more map applications, navigation applications, messaging applications, calendar applications, social networking applications, Internet browsing applications, etc. By way of example, a map application 111a may allow a user of the UE 101 to input a textual query string to search for a specific location on a map, a navigation application 111b may allow a user of the UE 101 to input a textual query string to search for a specific starting point, etc. The UE 101 may also include a geo-coding manager 113. In one embodiment, the geo-coding manager 113 interfaces with the geo-coding platform 103 for composing geo-coding requests based on textual query strings entered at the UE 101. In one embodiment, one or more applications 111 may access the geo-coding platform 103 directly, without going through the geo-coding manager 113, for composing geo-coding requests based on textual query strings entered at the UE 101. In one embodiment, all of the functions of the geo-coding platform 103 are embodied within and performed by the geo-coding manager 113.

The system 100 also includes a services platform 107 that includes one or more services 109a-109n (collectively referred to as services 109). The services 109 may include one or more map services, navigation services, messaging services, social networking services, etc. In one embodiment, a textual query string entered by a user of the UE 101 is sent to one or more services 109 at the services platform 107 for providing geo-coding information based on an address associated with the textual query string. The services 109 may include one or more geo-coding knowledge bases for providing geo-coding information. The system 100 also includes content providers 115a-115n (collectively referred to as content providers 115). The content providers 115 may provide content to the UE 101, the geo-coding platform 103, and the services 109 on the services platform 107. The content providers 115 may provide content to one or more geo-coding knowledge bases regarding, for example, one or more locations and/or address associated with map information.

The system 100 also includes the geo-coding platform 103 that provides address geo-coding that enhances query result quality while increasing the flexibility of textual query string inputs. In one embodiment, the geo-coding platform 103 acts as middleware between a client (e.g., UE 101) and a geo-coding knowledge base (e.g., one or more services 109 and/or one or more content providers 115) that determines a request for geo-coding information. The request may specify at least one textual query string (e.g., textual input). In response, the geo-coding platform 103 generates a geo-coding request based on the textual query string and determines to transmit the geo-coding request to one or more geo-coding knowledge bases, which may include or not include the geo-coding knowledge base that the request for geo-coding information was originally intended for. In generating the geo-coding request, the geo-coding platform 103 may use one or more words stored in the word database 117, which is in communication with the geo-coding platform 103. In one embodiment, the word database 117 may be embodied by one or more services 109 on the services platform 107 or may be embodied by one or more content providers 115.

By way of example, the communication network 105 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, near field communication (NFC), Internet Protocol (IP) data casting, digital radio/television broadcasting, satellite, mobile ad-hoc network (MANET), and the like, or any combination thereof.

The UE 101 is any type of mobile terminal, fixed terminal, or portable terminal including a mobile handset, station, unit, device, mobile communication device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The geo-coding platform 103 may determine a request for geo-coding information that originates at a client device (e.g., UE 101) and/or from an application interface (e.g., HTTP back-end request). The request for geo-coding information may be intended for the geo-coding platform 103 and/or directed to a geo-coding knowledge base. The request for geo-coding information may contain at least one textual input (e.g., textual query string). The textual query string may be in a natural language form. Based on the receipt of the request for geo-coding information, the geo-coding platform 103 may cause a generation of at least one geo-coding request based on the textual query string. In one embodiment, based on the original textual query string, the geo-coding request may be identical or approximately identical to the textual query string. In one embodiment, the geo-coding request may have one or more characters and/or words removed from the textual query string. The one or more characters and/or words may be removed from the beginning, end and/or middle of the textual query string. The geo-coding platform 103 may further determine to transmit the geo-coding request to at least one geo-coding knowledge base (e.g., the geo-coding knowledge base that was originally intended to receive the request for geo-coding information), one or more other geo-coding knowledge bases, or a combination thereof. The geo-coding platform 103 transmits the geo-coding request to the one or more geo-coding knowledge bases to generate one or more results associated with the address or location associated with the textual query string contained in the original request for geo-coding information. However, by generating the geo-coding request based on one or more algorithmic components, as discussed above, the geo-coding platform 103 may return better results than what would be generated based on the original request for geo-coding information. By way of example, where one or more characters and/or words may be in the textual query string that may cause one or more geo-coding knowledge bases to return zero results based on the original request for geo-coding information. However, by removing the one or more characters and/or words, the geo-coding platform 103 corrects the textual query string and allows for more accurate results, or one or more results entirely (e.g., where results would otherwise not have been found).

In one embodiment, in response to the geo-coding platform 103 determining to transmit the geo-coding request to one or more geo-coding knowledge bases, the geo-coding platform 103 processes one or more of the returned results with respect to at least one geo-coding request to determine one or more similarity values associated with the one or more results. In one embodiment, the geo-coding platform 103 initially generates the geo-coding request without changing the original textual query string contained in the request for geo-coding information. Thus, for example, the geo-coding request may be identical or approximately identical to the original textual query string in the request for geo-coding information. Upon receiving one or more results for the geo-coding request, the geo-coding platform 103 determines similarity values for the one or more results. The similarity values correspond to, for example, how similar the address or location for the one or more results match the address or location associated with the textual query string. Further, the geo-coding platform 103 determines whether a highest similarity value of one of the one or more results satisfies at least one threshold. For example, the geo-coding platform 103 selects the result with has the highest similarity result (e.g., most closely matches the address or location associated with the textual query string). The geo-coding platform 103 then determines whether the similarity value satisfies the threshold by, for example, exceeding the threshold thereby indicating that the result with the highest similarity value closely corresponds to the address or location of the textual query string. In one embodiment, if the highest similarity value associated with a result does not satisfy the threshold, the geo-coding platform 103 may subsequently process the textual query string by removing one or more characters and/or words until at least one result is associated with a similarity value that satisfies at least one threshold. The process of sending a geo-coding request to one or more knowledge bases may repeat until a result is returned that is associated with a similarity value that satisfies at least one threshold. In the event that a result is not returned that satisfies the at least one threshold after subsequent processing of the textual query string, the query for the address or location associated with the original textual query string fails and the user is notified accordingly.

In one embodiment, the geo-coding platform 103 processes one or more results of the geo-coding request being processed by one or more geo-coding knowledge bases, the geo-coding request and/or the textual query string to generate one or more word vectors. In one embodiment, the geo-coding platform 103 processes the one or more results, the geo-coding request and/or the textual query string to generate associated word vectors, with each word constituting a parameter of the word vector. By way of example, for a result of “No. 5 Donghuan Middle Road, Daxing, Beijing, China”, the word vector W would be [“No.”, “5”, “Donghuan”, “Middle”, “Road”, “Daxing”, “Beijing”, “China”]. In one embodiment, the geo-coding platform 103 processes the one or more results, the geo-coding request and/or the textual query string to make the spatial order associated with the words uniform. By way of example, the geo-coding platform 103 will process the one or more results, the geo-coding request and/or the textual query string to make the spatial association of the words in each uniform from to, for example, a small to a large spatial scale. In one embodiment, the geo-coding platform 103 will order the words of the word vectors associated with the one or more results and/or the geo-coding request according to the spatial formatting of the original textual query string. In one embodiment, the geo-coding platform 103 also translates the one or more results, the geo-coding request and/or the textual query string into one language (e.g., a universal or international language), such as English for processing. Although listed in the above order, the geo-coding platform 103 may generate the word vectors, order the words according to the spatial order, and translate the language in any order.

After determining the one or more word vectors and associated one or more words for the word vectors, the geo-coding platform 103 determines similarity values based on a word weighting and/or an original query weighting associated with the one or more words and/or word vectors. With respect to the word weighting, in one embodiment, the geo-coding platform 103 causes a comparison of one or more words of the one or more word vectors of the one or more results, the geo-coding request and/or the textual query string to an ignore-word list and/or a low-weight word list. The ignore-word list determines whether a particular word for a word vector is used to calculate a similarity value for the associated word vector. The low-weight word list determines whether a particular word, although used to calculate the similarity value for the associated word vector, is given a lower weight based on, for example, the frequency of the word appearing in word vectors. By way of example, words that often appear in address lend little weight in determining the similarity if they are always in addresses. Further, in one embodiment, the geo-coding platform 103 determines a significance weight of the one or more words of the one or more vectors based on an order of the one or more words in the one or more word vectors. By way of example, words appearing in the beginning of a result or textual query string may have more significance than words appearing at the ending of a result or textual query string based on the spatial ordering (e.g., beginning words in the English language often have a finer level of granularity and, therefore, have a higher significance). Based on the comparison and/or the significance weight, the geo-coding platform 103 determines the word weight for the one or word vectors associated with the one or more results, the geo-coding request and/or the textual query string.

With respect to the original query weighting, the geo-coding platform 103 assigns a weighting factor to a result if the result is based on a geo-coding request that is the result of a parsed (e.g., the noise/flagged characters and/or words are removed) textual query string rather than the original textual query string. The weighting factor of the original query weighting is determined based on, for example, empirical studies, such as upon the percentage of parsed addresses with correct responses upon training datasets.

As discussed above, in one embodiment, the geo-coding platform 103 may determine to transmit a geo-coding request to one or more geo-coding knowledge bases to generate one or more results associated with a location or address and with the geo-coding request. In one embodiment, the geo-coding platform 103 may transmit a geo-coding request to a plurality of geo-coding knowledge bases in parallel and obtain one or more results from the plurality of geo-coding knowledge bases at the same time. The geo-coding platform 103 may then process the one or more results to determine a highest similarity value associated with one of the results. In one embodiment, the geo-coding platform 103 may transmit a geo-coding request to a plurality of geo-coding knowledge bases in series and obtain one or more results from one of the plurality of geo-coding knowledge bases in series. When transmitting the geo-coding requests to the plurality of geo-coding knowledge bases in series, the geo-coding platform 103 may process and analyze the results from one geo-coding knowledge base, and (potentially) do not have to transmit the geo-coding request to subsequent geo-coding knowledge bases if the first (or previous) geo-coding knowledge base returns a result associated with a similarity value above at least one threshold.

In one embodiment, the plurality of geo-coding knowledge bases may be organized according to a prioritized ordering. The geo-coding request may be transmitted to the plurality of geo-coding knowledge bases in series according to the prioritized ordering. Thus, the geo-coding request may be transmitted to a geo-coding knowledge base of a highest priority first, and one or more results may be returned to the geo-coding platform 103 based on the request. If the one or more results do not have a similarity value that satisfies at least one threshold, the same geo-coding request may be transmitted to a geo-coding knowledge base of a next highest priority, and so on until either a similarity value associated with a result satisfies the at least one threshold or there are no more geo-coding knowledge bases to transmit the request to and none of the results are associated with the similarity value that satisfies the at least one result.

In one embodiment, the geo-coding platform 103 determines one or more characters and/or words within the textual query string that are associated with one or more synonyms. In one embodiment, the one or more synonyms may correspond to one or more characters and/or words that have approximately the same meaning as the one or more characters and/or words in the textual query string. By way of example, the word “house” may correspond to the synonyms home, residence, dwelling, abode, etc. In one embodiment, the one or more synonyms may correspond to one or more characters and/or words in another language that have the same meaning as the one or more characters and/or words in the original textual query string. By way of example, the English word “south” may correspond to the Chinese Pinyin-transcribed synonym “nan” and the English word “garden” may correspond to the Chinese Pinyin-transcribed synonym “yuan.” In response to determining an association with one or more synonyms, the geo-coding platform 103 causes a replacement of the one or more characters and/or words with the one or more synonyms to generate, at least in part, a geo-coding request. Thus, the geo-coding platform 103 may modify the textual query string of a request for geo-coding information by replacing one or more characters and/or words with one or more synonyms to generate one or more results where without the synonyms one or more results may not otherwise be obtained.

In one embodiment, the geo-coding platform 103 may cause the generation of at least one geo-coding request based on removing one or more characters and/or words from the textual query string. Additionally, if the geo-coding platform 103 already generated a geo-coding request, the geo-coding platform 103 may generate a geo-coding request based on removing one or more characters and/or words from the previously generated geo-coding request. The one or more characters and/or words removed are removed to, for example, generate one or more results based on the generated geo-coding request rather than, for example, receiving no results as a result of transmitting the original textual query string to one or more knowledge bases.

The geo-coding platform 103 may determine one or more noise characters and/or one or more noise words in the textual query string and/or a previously created geo-coding request. The one or noise characters and/or words are determined based on a comparison of one or more characters and/or one or more words in the textual query string and/or the previously generated geo-coding result to one or more characters and/or words in a noise-word list in the word database 117. Upon determining the one or more noise character and/or words, the geo-coding platform 103 removes the noise characters and/or words from the textual query string and/or the previously created geo-coding request to generate a geo-coding request that may then be transmitted to one or more geo-coding knowledge bases.

The geo-coding platform 103 may determine one or more flagged characters and/or one or more flagged words in the textual query string and/or a previously created geo-coding request. The one or more flagged characters and/or words are determined based on a comparison of one or more characters and/or words in the textual query string and/or the previously created geo-coding request to one or more characters and/or words in a flagged-word list in the word database 117. Upon determining the one or more flagged characters and/or words, the geo-coding platform 103 removes the flagged characters and/or words from the textual query string and/or the previously created geo-coding request to generate a gee-coding request that may then be transmitted to one or more geo-coding knowledge bases.

By way of example, the UE 101, the geo-coding platform 103, the services platform 107 and the content providers 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

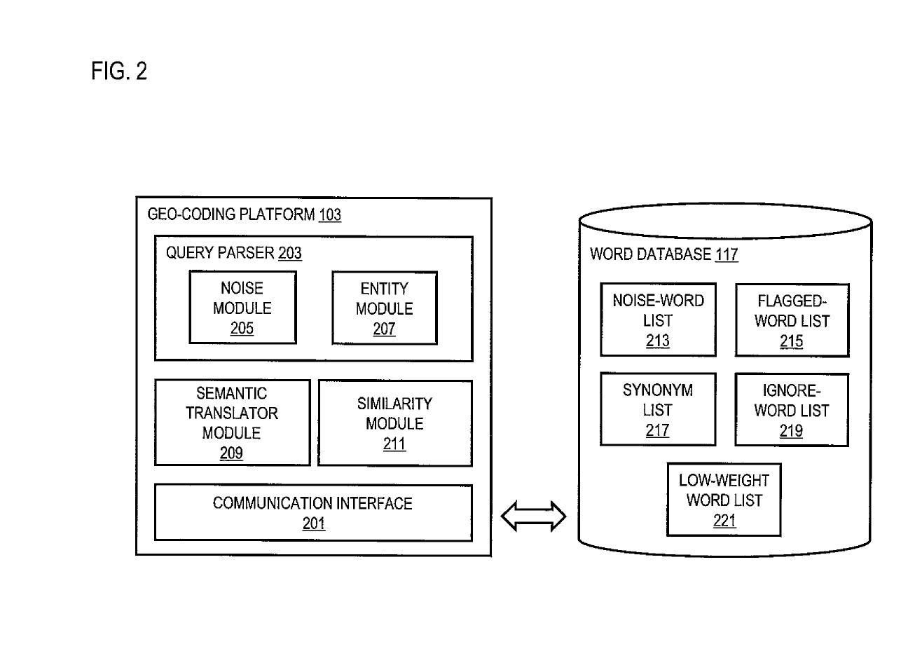

FIG. 2 is a diagram of the components of a geo-coding platform 103 and a word database 117, according to one embodiment. By way of example, the geo-coding platform 103 includes one or more components for providing address geo-coding that enhances query result quality while increasing the flexibility of textual query strings. It is contemplated that the functions of these components may be combined in one or more components or performed by other components of equivalent functionality, such as by the geo-coding manager 113. In this embodiment, the geo-coding platform 103 includes a communication interface 201, a query parser 203, a semantic translator module 209, and a similarity module 211. The query parser 203 of the geo-coding platform 103 also includes a noise module 205 and an entity module 207.

The communication interface 201 interfaces with the UE 101, the services platform 107 including the services 109, and the content providers 115 to allow these elements of the system 100 to communicate with the geo-coding platform 103. In one embodiment, the communication interface 201 allows end-user communications from the UE 101, one or more services 109 and one or more content providers 115, as well as back-end communications from one or more services 109, one or more content providers 115 or through a back-end HTTP request associated with the UE 101.

The query parser 203 parses and analyzes the textual addresses of textual query strings using natural language processing methods. In one embodiment, the query parser 203 may also act as a control unit to, for example, cause a transmission of one or more geo-coding requests to one or more services 109 and/or content providers 115 (e.g., the geo-coding knowledge bases). The query parser 203 may also generate one or more user interfaces at the UE 101, or interface with one or more applications 111 at the UE 101 for generating one or more user interfaces.

In one embodiment, the query parser 203 processes one or more results, the geo-coding request and/or the textual query string to generate one or more word vectors. In one embodiment, the query parser 203 processes the one or more results, the geo-coding request and/or the textual query string to generate associated word vectors, with each word constituting a parameter of the word vector. Further, in one embodiment, the query parser 203 processes the one or more results, the geo-coding request and/or the textual query string to make the spatial order associated with the words uniform. By way of example, the geo-coding platform 103 will process the one or more results, the geo-coding request and/or the textual query string to make the spatial association of the words in each uniform from, for example, a small to a large spatial scale. In one embodiment, the geo-coding platform 103 will order the words of the word vectors associated with the one or more results and/or the geo-coding request according to the spatial formatting of the original textual query string. In one embodiment, the query parser 203 also translates the one or more results, the geo-coding request and/or the textual query string into one language (e.g., a universal or international language) for processing.

In one embodiment, the query parser 203 includes the noise module 205. The noise module 205 compares one or more characters and/or words in the original textual query string or a previously generated geo-coding request to one or more characters and/or words in a noise-word list to determine one or more noise words to remove from the textual query string or the previously generated geo-coding request to generate a (or another) geo-coding request. By way of example, in a natural language address string, the location entities are usually specified in a spatial-granular order, such as room→floor→building→street→district→city→county→state→region→country. However, in some instances, an address string entered in a textual query string by a user will contain too fine-granular location entities in the beginning of the address string. By scanning the beginning of the address string (or the ending depending on the natural language), the noise module 205 can remove the noise words contained in the textual query string based on the comparison of the words in the string and the words in a noise-word list. In one embodiment, the noise module 205 performs multiple scans on the beginning and/or the end of the textual query string and/or the previously created geo-coding request to remove the noise characters and/or words, repetitively, when, for example, a transmission of a generated geo-coding request to one or more geo-coding knowledge bases yields zero results or results that do not have similarity scores that satisfy at least one threshold.

In one embodiment, the query parser 203 includes the entity module 207. The entity module 207 extracts characters and/or words from the textual query string and/or the previously generated geo-coding request by comparing one or more characters and/or words to the flagged-word list. Although the flagged characters and/or words may not be related to a spatial scale, such as the noise words, the flagged characters and/or words are determined, based on empirical training of datasets, to cause errors or zero results in response to queries at one or more knowledge bases.

The semantic translator module 209 replaces one or more characters and/or words in the textual query string or a previously generated geo-coding string with one or more synonyms. In one embodiment, the one or more synonyms include words within the same language (e.g., English, Chinese, etc.) as the original textual query string. Thus, for example, where one word may not be recognizable by one or more geo-coding knowledge bases, a synonym of the word may be recognizable by the same one or more geo-coding knowledge bases. In one embodiment, the geo-coding platform 103 supports multiple languages, such as Chinese and English. In such an embodiment, the one or more synonyms may cross languages, such that a synonym of a word in English may constitute the Chinese Pinyin word. For example, geo-coding knowledge bases may recognize either English-translated words or Chinese Pinyin-transcribed words, but not both. In which case, an original textual query string that includes both English-translated words and Chinese Pinyin-transcribed words may not be compatible with or recognizable by geo-coding knowledge bases. Thus, the semantic translator module 209 replaces one or more words in the textual query string and/or a previously generated geo-coding with one or more synonyms. In one embodiment, the semantic translator module 209 determines to make the replacement based on a synonym list and/or a determination as to whether the textual query string includes more than one language.

The similarity module 211 calculates the one or more results generated by one or more knowledge bases based on a geo-coding request. Each of the one or more results is associated with a geographical location that contains, for example, GPS coordinates, a formatted address text stored in the geo-coding knowledge base that is similar to the textual query string, and other information associated with the location. The similarity module 211 computes the similarity of the one or more results to the textual query string initially entered by the user to determine which result, if any, is most likely the address location requested by the user. In one embodiment, rather than the query parser 203, the similarity module 211 may perform the functions of translating the textual query string and/or one or more results into English (if necessary) providing uniform word order of location entities in the textual query string and the one or more results, and converting the textual query string and the one or more results into word vectors, as discussed above.

Subsequently, the similarity module 211 performs word weighting based on word co-occurrence in the textual query string and the one or more results, for example, comparing the formatted address texts of the one or more results with the textual query string. For each word in a result, the similarity module 211 determines if the word is in an ignore-word list and whether the word also exists in the textual query string. Thus, the similarity module 211 applies a word weighting to each word in the one or more results according to the equation:

$$f ( w ) = \{ \begin{matrix}0 \\ 1\end{matrix}$$

where, w is the word in a result and f(w)=0 if the word w does not exist in the textual query string or belongs to the ignore-word dictionary, and f(w)=1 if the word w exists in the textual query string and does not belong to the ignore-word dictionary. In one embodiment, where the word w does not exist in the textual query address but a synonym of the word does, the function return value f(w) still equals 1 for this particular word w that exists in the result but not in the textual query string.

For each word in a result, the similarity module 211 also determines if the word is in a low-weight word list. A low-weight word list (as discussed below) includes one or more characters and/or words that are commonly in address strings and therefore have a low weight. The similarity module 211 applies a low-word weighting to each word in the one or more results according to the equation:

$$g ( w ) = \{ \begin{matrix}0.5 \\ 1\end{matrix}$$

where w is the word in a result and g(w)=0.5 if the word w belongs to a low-weight list, and g(w)=1 if the word w does not belong to the low-weight list.

Further, the similarity module 211 determines the significance for each word in the one or more results. The similarity module 211 applies a significance weight to the each word w in the one or more results according to the equation:

[symbol]

where i=1, 2, 3, . . . is the word order of w in the result. Thus, larger weights are assigned to words in the one or more results that represent entities of a smaller spatial scale and tend to more significantly distinguish one address or location from another based on being in the beginning of the result.

Further, the similarity module 211 adds a blurring penalty factor if a result R is the result of a parsed geo-coding request (e.g., a parsed and analyzed textual query string that has been processed to remove noise characters and/or words, and/or flagged characters and/or words) but not the original textual query string. The similarity module 211 applies a blurring penalty factor to each result of the one or more results according to the equation:

$$v ( R ) = \{ \begin{matrix}0.83099 \\ 1\end{matrix}$$

where v(R)=0.83099 if R is not a result of the original textual query string without being parsed and analyzed, and v(R)=1 if R is a result of the original textual query string. The value of 0.83099 could be derived from empirical studies based on, for example, the percentage of parsed addresses with correct responses upon training datasets.

Based on the foregoing analysis, the similarity module 211 determines the similarity value of each result R in the one or more results with respect to the original textual query string contained in the request for geo-coding information according to the equation:

$$similarity ( R ) = v ( R ) \times [ {\sum }_{i = 1}^{n} s ( {w}_{i} ) \times f ( {w}_{i} ) \times g ( {w}_{i} ) ]$$

where (w₁, w₂, w₃, . . ..) corresponds to each word w₁ of the word vector of the result R. Thus, for each result of the one or more results generated based on a geo-coding request, a similarity value similarity(R) is determined. After determining the similarity values of the one or more results, the similarity module 211 compares the similarity values of the one or more results to a threshold τ for result filtering. If a similarity value associated with a result is lower than the threshold τ, the result is considered not valid and will not be returned to the user. In one embodiment, the value for threshold τ may be set to 0.63 based on experiments. In one embodiment, if none of the results that are returned have a similarity value above the threshold; a subsequent geo-coding request is generated based on subsequent parsing and analysis of the textual query string and/or the previously generated geo-coding request based on the discussion above.

In communication with the geo-coding platform 103 is the word database 117. The word database 117 includes one or more word lists (dictionaries) used in generating the one or more geo-coding requests. In one embodiment, the word database 117 includes a noise-word list 213, a flagged-word list 215, a synonym list 217, an ignore-word list 219 and a low-weight word list 221.

With respect to the noise-word list 213, in a natural language textual query string, the location or address is generally specified in a spatial-granular order, such as a fine to coarse granular order (e.g., building→street→district→city→country, etc.), or reversely a coarse to fine granular order. Generally, the language determines the order of the granularity. For example, the English grammar habit is to write a textual query string of an address from the finest to the coarsest location granularity, whereas for the Chinese grammar habit is from coarsest to finest. Thus, in some textual query strings entered by a user or associated with a backend API request, the string may contain too fine-granular characters or words in the head (e.g., English) or tail (e.g., Chinese) of the string that may not be understandable for a geo-coding knowledge base. Accordingly, the noise-word list 213 contains characters and/or words that constitute noise words that may cause an empty set of results returned if the textual query string containing the noise words is queried at a geo-coding knowledge base as entered.

In one embodiment, the noise-word list 213 may be built based on training datasets of user address queries and system-internal expert knowledge. Thus, characters and/or words that describe too fine-granular location entities to be understandable by one or more geo-coding knowledge bases according to the training datasets are denoted as noise characters and/or words and entered as part of the noise-word list 213. In one embodiment, the noise-word list 213 may constitute a multi-level list such that, for example, one level includes a list of characters and/or words of a fine level of location granularity, and another level includes a list of characters and/or words of a less fine level of granularity, but still fine enough so as to possibly cause zero results if the characters and/or words are left in the original textual query string. In one embodiment, there may be a plurality of levels of location granularity in the noise-word list 213, with each level varying to some degree in granularity with another level. Examples of noise characters and/or words may include “No. 33” in the textual query string “No. 33, Shenggu South Li, N 3rd Ring Road Middle, Beijing, China”, and “D1-7 Floor 1, Cool Car Small Town” in “D1-7 Floor 1, Cool Car Small Town, No. 1 Jinchan West Rd, Beijing, China.”

With respect to the flagged-word list 215, there are some situations where including all potential noise characters and/or words in the noise-word list 213 are difficult because of the diversity and complexity of natural language. Thus, there are some characters and/or words that may be included in a textual query string that are not defined or considered as noise characters and/or words, but still cause the textual query string to be unrecognizable to a geo-coding knowledge base. As a result, the inclusion of a flagged-word list 215 helps alleviate any deficiencies of the noise-word list 213. The flagged-word list 215 may as well be built based on training datasets and expert knowledge, and include characters and/or words that indicate the appearance of a kind of location entity of a certain spatial scale in a textual query string. In one embodiment, each line in the flagged-word list 215 may contain one or more words and/or phrases that are categorized as representing location entities of roughly the same spatial level/scale (e.g., “street”, “road” and “avenue”; “hotel” and “restaurant”). Further, in one embodiment, the appearance order of the lines within the flagged-word list 215 indicates the scale order (e.g., smallest to largest, or largest to smallest) of their corresponding location entities (e.g., “shop” and “shopping mall”).

Removal of the flagged characters and/or words may cause the textual query string to be recognizable by the geo-coding knowledge bases. Different from the noise characters and/or words removed that exactly appear in the noise-word list 213, the flagged characters and/or words removed consist of characters and/or words that appear in the flagged-word list 215 and one or more other words adjacent to them in the textual query string that represent particular location entities in combination. In one embodiment, the words adjacent to the characters and/or words in the flagged-word list 215 that should be removed together may be identified through forward/backward tracking and are bounded by the sentence delimiters (e.g., the comma or space character) in natural language. Examples of flagged characters and/or words include “Shop” and “shopping mall” in the textual query string “Shop B 128, underground shopping mall, Huamao Center, No. 87 Jiannguo Road, Beijing”, or “Yuan” in “Yingjing Yuan, Guiyuan South Li, Daxing District, Beijing.” In addition to these flagged characters and/or words, the adjacent words that are removed together with them during query parsing for a geocoding request include “B128”, “underground” or “Yingjing”.

With respect to the synonym list 217, a word in a textual query string may correspond to one or more synonyms such that, for example, the original word in the textual query string causes a geo-coding knowledge base to not recognize the address or location, but replacing the original word with a synonym causes the geo-coding knowledge base to recognize the address or location. Thus, in one embodiment, the synonym list 217 includes one or more lines of characters and/or words based on the characters and/or words being synonyms. In one embodiment, for each line, one or more characters and/or words correspond to the primary character and/or word used to replace the original character and/or word in the textual query string. In one embodiment, for each line, any one of the characters and/or words may replace the original character and/or word in the original textual query string.

In one embodiment, the geo-coding platform 103 supports multiple different languages. Thus, the synonym list 217 also includes entries including characters and/or words and their corresponding characters and/or words in multiple different languages. Thus, for example, a textual query string may be in English except for one word, which may be in, for example, Chinese Pinyin. The synonym list 217 includes the Chinese Pinyin character in one entry along with one or more English words and/or phrases that are the English translation of the Chinese Pinyin character. The synonym list 217 may also include words and/or phrases in other languages associated with the Chinese Pinyin characters besides English. Thus, the synonym list 217 may also allow the geo-coding platform 103 to replace one or more characters and/or words in the textual query string in one language with one or more characters and/or words in another language to, for example, generate a geo-coding request entirely in one language. Accordingly, for example, where a geo-coding knowledge base does not recognize the textual query string because the string is not originally in one language, the geo-coding knowledge base will recognize the geo-coding request because the request is one language.

In one embodiment, for example, for a particular Chinese location character, a geo-coding knowledge base may recognize either the English-translated word or the Pinyin-transcribed word, but not both. The synonym list 217 may contain the English to Chinese Pinyin mapping for a set of commonly used words representing location entities. Using the synonym list 217, the Chinese location character may be converted, if necessary, to the format (e.g., Chinese Pinyin character or English word) that the geo-coding knowledge base recognizes.

In one embodiment, the word database 117 includes an ignore-word list 219. The ignore-word list 219 is used in determining similarity scores for one or more results of a geo-coding request sent to one or more geo-coding knowledge bases. The ignore-word list 219 includes one or more characters and/or words that may be present in one or more results from a geo-coding knowledge base that the geo-coding platform 103 ignores or skips when determining the similarity results for the one or more results. The ignore-word list 219 is generated based on system-learned skip words.

In one embodiment, the word database 117 includes a low-weight word list 221. The low weight-word list 221 is used in determining similarity scores for one or more results of a geo-coding request sent to one or more geo-coding knowledge bases. The low-weight word list 221 includes one or more characters and/or words that may be present in one or more results from a geo-coding knowledge base that the geo-coding platform 103 assigns lower weights to because, for example, the characters and/or words commonly or frequently appear in many textual query strings and/or results from geo-coding knowledge bases. For example, low-weight words may include the generic of a street name, such as road, street, place, etc.

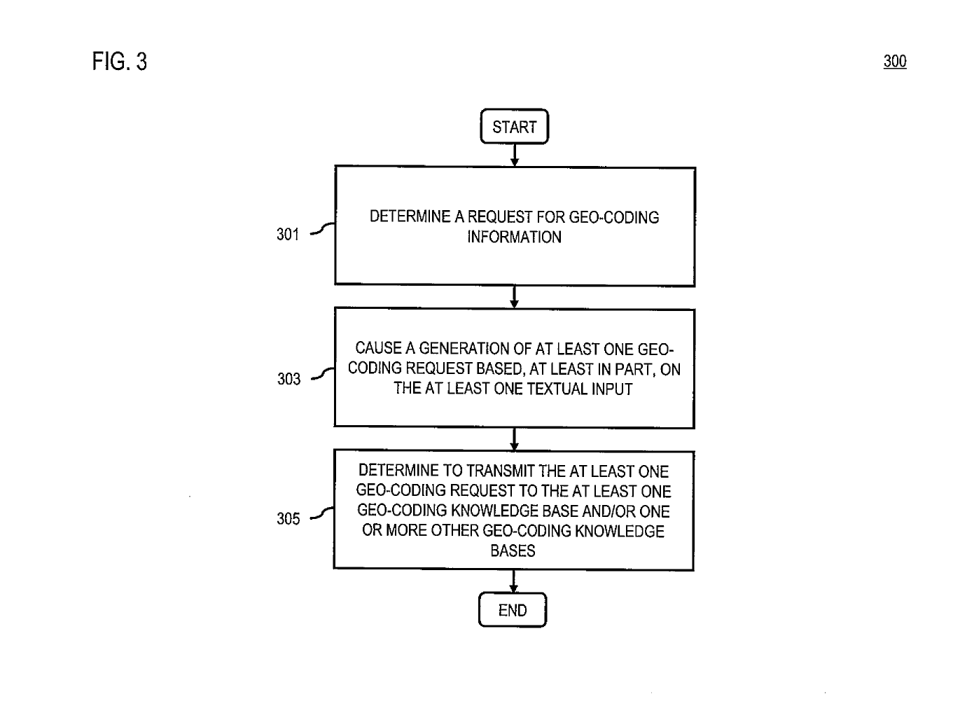

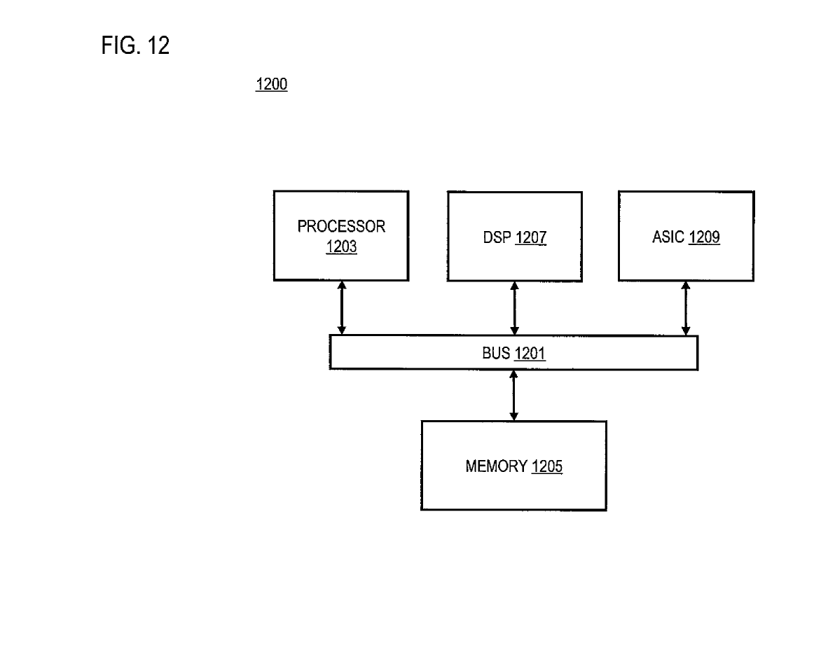

FIG. 3 is a flowchart of a process for providing address geo-coding that enhances query result quality while increasing the flexibility of textual query string inputs, according to one embodiment. In one embodiment, the geo-coding platform 103 performs the process 300 and is implemented in, for instance, a chip set including a processor and a memory as shown in FIG. 12. In step 301, the geo-coding platform 103 determines a request for geo-coding information. The request may originate with a client device and be directed to one or more geo-coding knowledge bases and/or the geo-coding platform directly. The request may also originate from a back-end source, such as from an application-developer interface (e.g., HTTP request) and may contain other parameters. The request for geo-coding information will specify at least one textual input in the form of a textual query string that specifies an address or location to translate into geo-coding information. By way of example, a textual query string may constitute “1600 Amphitheater Parkway, Mountain View, Calif.”.

In step 303, the geo-coding platform 103 causes, at least in part, a generation of at least one geo-coding request based, at least in part, on the textual query string. After determining the textual query string, the geo-coding platform 103 may generate a geo-coding request without modifying the textual query string, or may perform one or more natural language processing methods on the textual query string to generate a geo-coding request that will be compatible with or recognizable by one or more geo-coding knowledge bases. Thus, the natural language processing methods allow the geo-coding platform 103 to take a textual query string that may not result in any geo-coding information results and generate a geo-coding request that will result in one or more results.

Then, in step 305, the geo-coding platform 103 determines to transmit the geo-coding request to at least one geo-coding knowledge base. The at least one geo-coding knowledge base may constitute the geo-coding knowledge base that the original request for geo-coding information was intended for. Alternatively, the geo-coding platform 103 may transmit the geo-coding request to one or more geo-coding knowledge bases other than the originally intended geo-coding knowledge base. By sending the geo-coding request to at least one geo-coding knowledge base, including geo-coding knowledge bases that may not have been the originally intended, the geo-coding platform 103 enhances the results returned based on the geo-coding request.

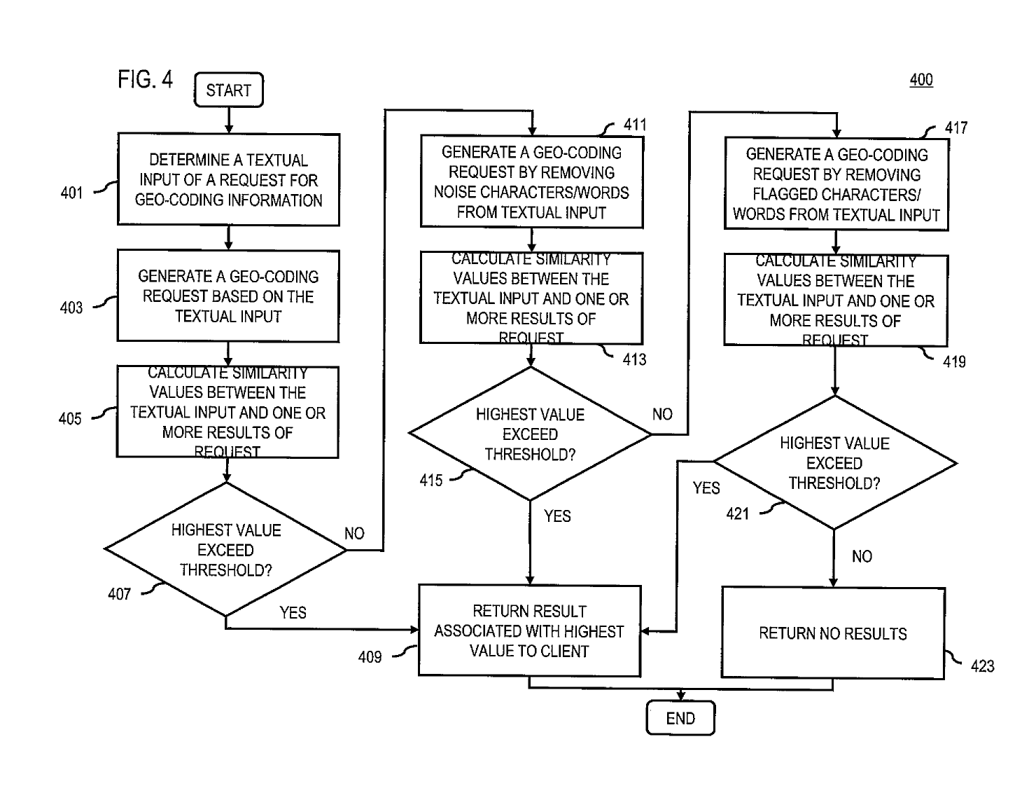

FIG. 4 is a flowchart of an overview of the process for providing address geo-coding that enhances query result quality while increasing the flexibility of textual query string inputs based on modified textual query strings, according to one embodiment. In one embodiment, the geo-coding platform 103 performs the process 400 and is implemented in, for instance, a chip set including a processor and a memory as shown in FIG. 12. In step 401, the geo-coding platform 103 determines a textual input of a request for geo-coding information. As discussed above, the request may be sent from a client device (e.g., UE 101) to a geo-coding knowledge base (e.g., service 109 or content providers 115). The request will contain a textual query string that is associated with an address or a location.

In step 403, the geo-coding platform 103 generates a geo-coding request based on the textual query string. The geo-coding request is generated based on one or more natural language processing (NLP) methods. In one embodiment, the first time the textual query string is received, the geo-coding request may be identical (or approximately identical) to the textual query string. After generating the geo-coding request, the geo-coding platform 103 transmits the request to a geo-coding knowledge base to determine one or more results associated with the request based on the geo-coding knowledge base.

In step 405, the geo-coding platform 103 receives the one or more results and calculates the similarity values between the one or more results and the textual query string that was the original request for geo-coding information. The determination of the similarity values may be based on several processes associated with, for example, weighting words within the one or more results, as discussed in detail below.

In step 407, the geo-coding platform 103 determines whether a highest similarity value associated with one of the results satisfies a threshold. The threshold may be based on experiments using one or more training datasets. If the similarity value satisfies the threshold, the process 400 proceeds to step 409. If the similarity value does not satisfy the threshold, the process 400 proceeds to step 411.

In step 411, when the similarity value of the result with the highest similarity value from step 405 does not satisfy the threshold, the geo-coding platform 103 generates a subsequent geo-coding request by removing one or more noise characters and/or one or more noise words from the textual query string. As discussed above, and in detail below, noise characters and/or words are associated with too fine-granular spatial location such that the geo-coding knowledge bases do not recognize the characters and/or words. In which case, queries that contain the characters and/or words may not be recognizable by the geo-coding knowledge bases. By removing the noise characters and/or words, the resulting geo-coding request may be recognizable by the geo-coding knowledge bases. After generating the subsequent geo-coding request, the geo-coding platform 103 transmits the request to a geo-coding knowledge base to determine one or more results associated with the request based on the geo-coding knowledge base.

In step 413, the geo-coding platform 103 receives the one or more subsequent results and calculates the similarity values between the one or more subsequent results and the textual query string that was the original request for geo-coding information. The determination of the similarity values may be based on several processes associated with, for example, weighting words within the one or more results, as discussed in detail below.

In step 415, the geo-coding platform 103 determines whether a highest similarity value associated with one of the subsequent results satisfies a threshold. As discussed above, the threshold may be based on experiments using one or more training datasets. If the similarity value satisfies the threshold, the process 400 proceeds to step 409. If the similarity value does not satisfy the threshold, the process 400 proceeds to step 417.

In step 417, when the similarity value of the result with the highest similarity value from step 413 does not satisfy the threshold, the geo-coding platform 103 generates another geo-coding request by removing one or more flagged characters and/or one or more flagged words from the textual query string. As discussed above, and in detail below, flagged characters and/or words are associated with characters and/or words that may not be classified as noise words but may also cause a query to not be recognizable by a geo-coding knowledge base. By removing the flagged characters and/or words, the resulting geo-coding request may be recognizable by the geo-coding knowledge bases. After generating another geo-coding request, the geo-coding platform 103 transmits the request to a geo-coding knowledge base to determine one or more results associated with the request based on the geo-coding knowledge base.

In step 419, the geo-coding platform 103 receives the one or more other results and calculates the similarity values between the one or more other results and the textual query string that was the original request for geo-coding information. The determination of the similarity values may be based on several processes associated with, for example, weighting words within the one or more results, as discussed in detail below.

In step 421, the geo-coding platform 103 determines whether a highest similarity value associated with one of the subsequent results satisfies a threshold. As discussed above, the threshold may be based on experiments using one or more training datasets. If the similarity value satisfies the threshold, the process 400 proceeds to step 409. If the similarity value does not satisfy the threshold, the process 400 proceeds to step 423.

In step 409, if a highest similarity value associated with one of the results from steps 405, 413, or 419 (depending on how far the process proceeded) satisfies the threshold, in one embodiment, the result associated with the highest similarity value is presented to the user associated with the request for geo-coding information. In one embodiment, all of the results associated with similarity values that satisfy a threshold are presented to the user. In one embodiment, the results associated with the top-K highest similarity values that satisfy a threshold are presented to the user, and K is a user-specified request parameter.

In step 423, if none of the similarity values associated with the one or more results satisfy the threshold value, or the geo-coding knowledge base returns zero results, the geo-coding platform 103 returns no results to the user. However, if the geo-coding platform 103 is transmitting the geo-coding request in series to multiple geo-coding knowledge bases, after step 421, rather than proceeding to step 423, the process 400 may instead repeat with a different geo-coding knowledge base (e.g., a geo-coding knowledge base of a different priority). Similarly, if the geo-coding platform 103 is transmitting the geo-coding request in series to multiple geo-coding knowledge bases, rather than proceeding to steps 411 and 417 if the highest similarity value associated with a result does not satisfy a threshold, steps 403 and 405; steps 411 and 413; or steps 417 and 419 may be repeated with a different geo-coding knowledge base (e.g., a geo-coding knowledge base of a different priority).

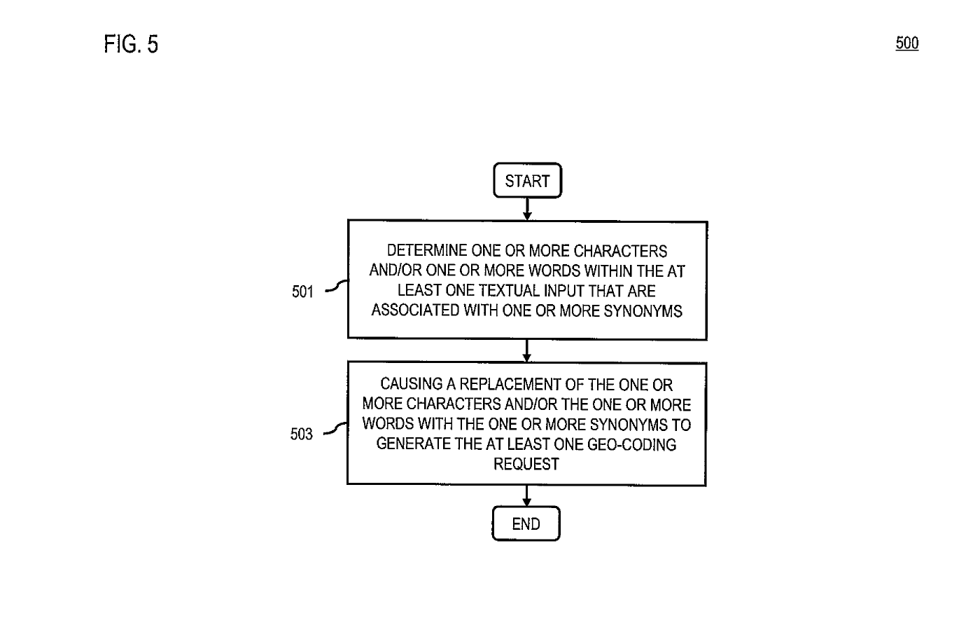

FIG. 5 is a flowchart of a process for replacing synonyms in a textual query string, according to one embodiment. In one embodiment, the geo-coding platform 103 performs the process 500 and is implemented in, for instance, a chip set including a processor and a memory as shown in FIG. 12. In step 501, the geo-coding platform 103 determines one or more characters and/or one or more words within the textual query string that are associated with one or more synonyms. The geo-coding platform 103 compares the words in the textual query string to a synonym list 217 to determine what words are associated with synonyms. In one embodiment, the synonyms are of the same language as the language of the textual query string. By way of example, a word within the textual query string may constitute “home”, which may be associated with the synonyms house, residence, dwelling, abode, etc. Because the textual query string may be natural language oriented, one or more words in the textual query string may not correspond to the word that is formally used to specify an address or location (e.g., such as “path” rather than “road”). Thus, the geo-coding platform 103 will determine the characters and/or words in the textual query string that may be, for example, not typically associated with specifying an address.

In one embodiment, the geo-coding platform 103 may support multiple languages, such as a local language and an international language. The geo-coding platform 103 may determine one or more characters and/or one or more words in the textual query string that correspond to the same or similar character or word in a different language. By way of example, a synonym for the word “south” in English is “nan” in Chinese Pinyin, or the word “garden” in English is “yuan” in Chinese Pinyin. Thus, the geo-coding platform 103 will determine the characters and/or words in the textual query string that are associated with one or more synonyms. Further, in one embodiment, where the geo-coding platform 103 has previously generated a geo-coding request based on the textual query string, rather than processing the textual query string, the geo-coding platform 103 may process the previously generated geo-coding request to determine synonyms.

In step 503, the geo-coding platform 103 causes a replacement of the one or more characters and/or the one or more words with the one or more synonyms to generate, at least in part, a geo-coding request. The replacement may be based on, for example, the one or more characters or the one or more words in the synonym list 217 that are determined to be the dominate character or word over the other listed synonyms. By way of example, the word “path” may be a synonym of the word “road”. However, the word “road” is typically in addresses rather than the word “path”. Thus, the word “path” may be replaced with the word “road”. Further, the replacement may be based on transforming the textual query string into all of one language. For example, some geo-coding knowledge bases recognize two different languages, but when one textual query string contains two different languages, the geo-coding knowledge bases may not be able to process the textual query string. By translating the one or more words into a different language, such that the textual query string comprises only one language, the geo-coding platform 103 generates a geo-coding request that is compatible with the geo-coding knowledge bases.

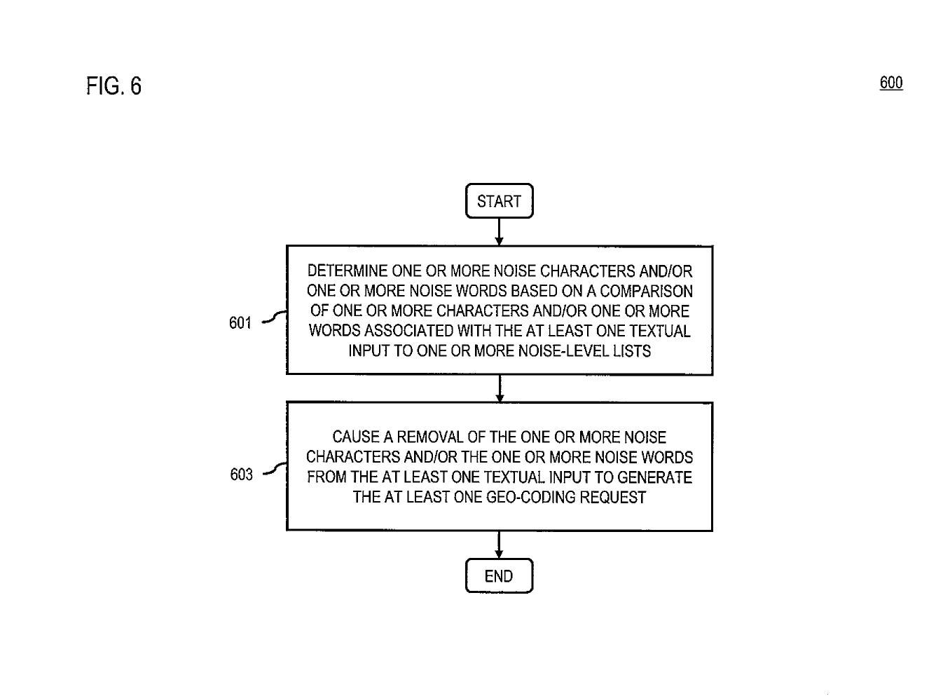

FIG. 6 is a flowchart of a process for removing noise characters and/or words from a textual query string, according to one embodiment. In one embodiment, the geo-coding platform 103 performs the process 600 and is implemented in, for instance, a chip set including a processor and a memory as shown in FIG. 12. In step 601, the geo-coding platform 103 determines one or more noise characters and/or one or more noise words based, at least in part, on a comparison of one or more characters and/or one or more words associated with the textual query string to a noise-word list 213. As discussed above, the word database 117 includes a noise-word list 213 that includes one or more characters and/or words that are associated with too fine-granular location for a geo-coding knowledge base to recognize. The geo-coding platform 103 uses the noise-word list 213 to determine the one or more noise characters and/or one or more noise words. In one embodiment, the noise-word list 213 may include multiple levels of noise characters and/or words. In which case, the geo-coding platform 103 may perform multiple determinations based on one or more of the different levels to determine the one or more noise characters and/or noise words. In one embodiment, where the geo-coding platform 103 has previously generated a geo-coding request based on the textual query string, rather than processing the textual query string, the geo-coding platform 103 may process the previously generated geo-coding request to determine one or more noise characters and/or one or more noise words.

In step 603, the geo-coding platform 103 causes, at least in part, a removal of the one or more noise characters and/or the one or more noise words from the textual query string to generate, at least in part, the geo-coding request. With the one or more noise characters and/or noise words removed from the textual query string, the noise characters and/or words are not present to affect the results of the geo-coding request at the one or more geo-coding knowledge bases.

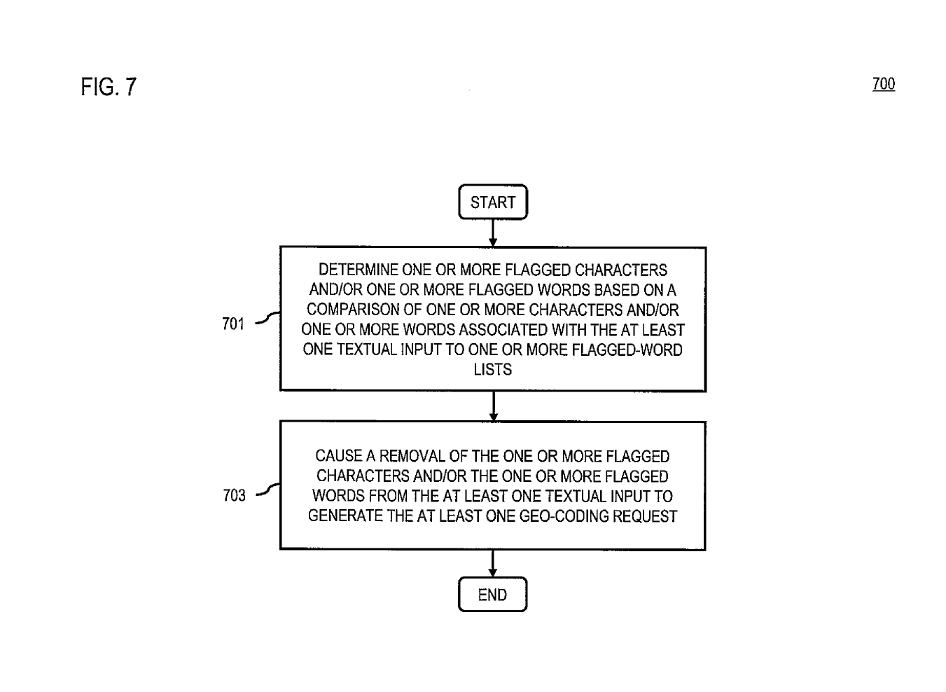

FIG. 7 is a flowchart of a process for removing flagged characters and/or words from a textual query string, according to one embodiment. In one embodiment, the geo-coding platform 103 performs the process 700 and is implemented in, for instance, a chip set including a processor and a memory as shown in FIG. 12. In step 701, the geo-coding platform 103 determines one or more flagged characters and/or one or more flagged words based, at least in part, on a comparison of one or more characters and/or one or more words associated with the textual query string to a flagged-word list 215. As discussed above, the word database 117 includes a flagged-word list 215 that includes one or more characters and/or words that may not be considered as noise words but still cause incorrect or zero results. The geo-coding platform 103 uses the flagged-word list 215 to determine the one or more flagged characters and/or one or more flagged words. In one embodiment, where the geo-coding platform 103 has previously generated a geo-coding request based on the textual query string, rather than processing the textual query string, the geo-coding platform 103 may process the previously generated geo-coding request to determine one or more flagged characters and/or one or more flagged words.

In step 703, the geo-coding platform 103 causes, at least in part, a removal of the one or more flagged characters and/or the one or more flagged words from the textual query string to generate, at least in part, the geo-coding request. With the one or more flagged characters and/or flagged words removed from the textual query string, the flagged characters and/or words are not present to affect the results of the geo-coding request at the one or more geo-coding knowledge bases.

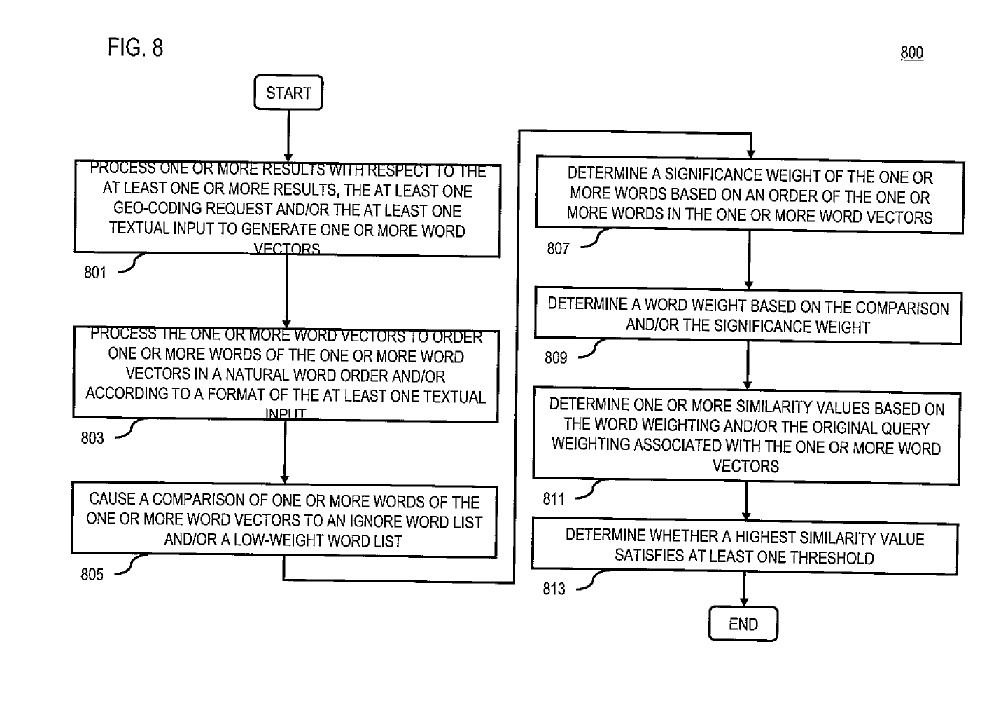

FIG. 8 is a flowchart of a process for determining similarity values for one or more results of a geo-coding request, according to one embodiment. In one embodiment, the geo-coding platform 103 performs the process 800 and is implemented in, for instance, a chip set including a processor and a memory as shown in FIG. 12. In step 801, the geo-coding platform 103 processes one or more results obtained from one or more geo-coding knowledge bases, the geo-coding request, the textual query string, or the combination thereof to generate one or more word vectors. For example, where a textual query string includes “No. 5 Donghuan Middle Road, Daxing, Beijing, China”, the word vector W would constitute [“No.”, “5”, “Donghuan”, “Middle”, “Road”, “Daxing”, “Beijing”, “China”], where the individual words that make-up the textual query string constitute the parameters of the word vector. In one embodiment, prior to generating the word vectors, the one or more results, the geo-coding request, the textual query string, or the combination thereof may be first translated into a specified language for processing based on one or more language translation services. By way of example, if the textual query string is originally in Chinese, the string may be first translated into English for subsequent processing.

In step 803, the one or more results, the geo-coding request, the textual query string, or the combination thereof are processed to make the words in the word vectors uniform in terms of a natural word order and uniform spatial scale (e.g., spatial scale from small to large). The geo-coding platform 103 makes the one or more results and the textual query string in the same spatial order for further processing to determine the similarity scores. By way of example, a result from a geo-coding knowledge base may be returned based on the format of “Beijing, China, Donghuan Middle Road No. 5.” In which case, the geo-coding platform 103 formats the result according to “No. 5 Donghuan Middle Road, Daxing, Beijing, China” to follow a natural language format or the format used in the textual query string.

In step 805, the geo-coding platform 103 causes, at least in part, a comparison of one or more words of the one or more words vectors of the one or more results to an ignore-word list, a low-weight word list, or a combination thereof. As discussed above, the ignore-word list determines whether the words of the one or more results should be ignored when determining a similarity value. Further, as discussed above, the low-weight word list determines whether the words of the one or more results should be given a lower weight when determining a similarity value. Based on a comparison of the one or more words of the one or more results to the ignore-word list 219 and the low-weight word list 221, and a comparison of the one or more words of the one or more results to the words within the textual query string, the geo-coding platform 103 generates weights associated with the words of the one or more results.

In step 807, the geo-coding platform 103 determines a significance weight of the one or more words of the one or more results based, at least in part, on an order of the one or more words in the one or more words vectors. Because the words have been ordered to correspond with their spatial scale, the order of the words indicates how fine of granular detail the words correspond to. As such, words appearing at, for example, the beginning of the results have finer granular detail and have more significance than words at the ending of the results.

In step 809, the geo-coding platform 103 determines a word weight based, at least in part, on the comparison of the one or more words of the one or more results to the words of the textual query string, the ignore-word list 219, and the low-weight word list 221, in addition to the significance weight of the one or more words.

In step 811, the geo-coding platform 103 determines one or more similarity values based, at least in part, on the word weighting, an original query weighting, or a combination associated with the one or more words vectors associated with the one or more results. The original query weighting, as discussed above, gives more significance to a result if the result is based on a geo-coding request that is based on the textual query string without performing, for example, noise-word elimination or flagged-word elimination. After determining the similarity values, in step 813, the geo-coding platform 103 determines the highest similarity value of the one or more results for determining if the highest similarity value satisfies a threshold. In one embodiment, whether the highest similarity value associated with a result satisfies a threshold determines whether subsequent processing of the textual query string is required to generate accurate results with respect to the textual query string.

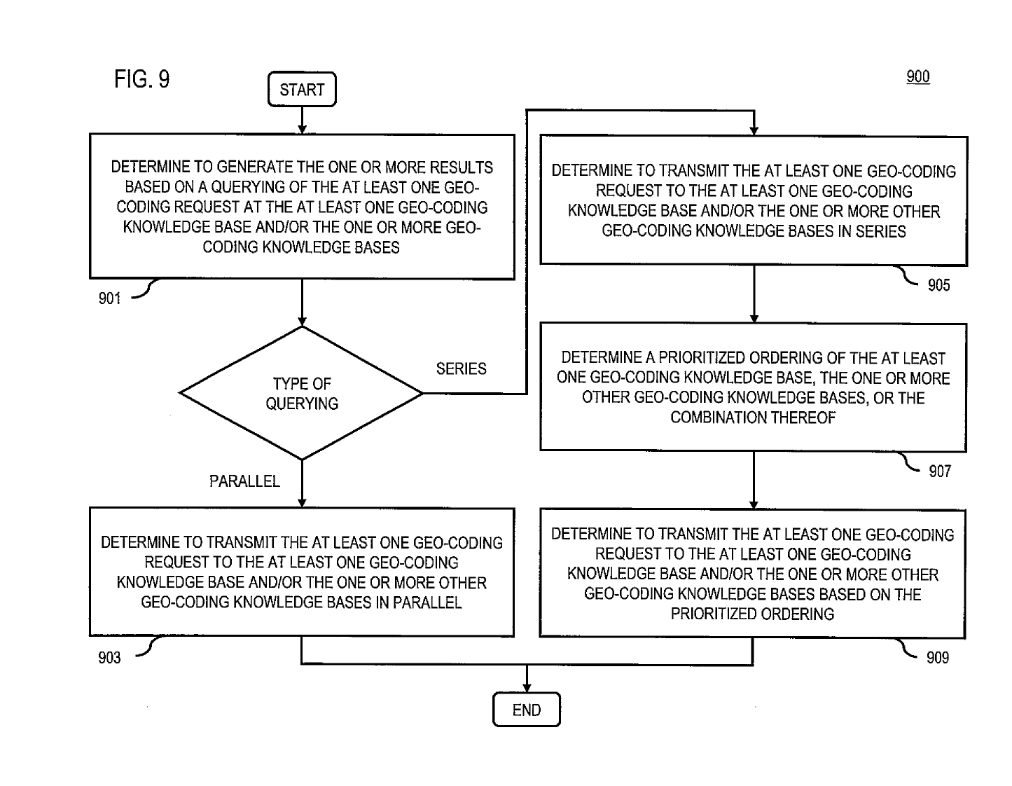

FIG. 9 is a flowchart of a process for determining a geo-coding knowledge base to transmit a geo-coding request to for generating one or more results, according to one embodiment. In one embodiment, the geo-coding platform 103 performs the process 900 and is implemented in, for instance, a chip set including a processor and a memory as shown in FIG. 12. In step 901, the geo-coding platform 103 determines to generate one or more results based, at least in part, on a querying of a geo-coding request at one or more geo-coding knowledge bases. The one or more geo-coding knowledge bases may include or exclude the geo-coding knowledge base that the original request for geo-coding information was intended for. In one embodiment, the geo-coding platform 103 determines to transmit the geo-coding request to one or more geo-coding knowledge bases in parallel. In which case, the process 900 proceeds to step 903. In one embodiment, the geo-coding platform 103 determines to transmit the geo-coding request to one or more geo-coding knowledge bases in series. In which case, the process 900 proceeds to step 905.

In step 903, the geo-coding platform 103 determines to transmit the geo-coding request to the one or more geo-coding knowledge bases in parallel. The geo-coding platform 103 causes a querying of the one or more geo-coding knowledge bases in parallel by transmitting the geo-coding request to all of the geo-coding knowledge bases at the same time. In response, the geo-coding knowledge bases return one or more results, which the geo-coding platform 103 processes to determine one or more similarity values associated with the one or more results. In one embodiment, a maximum querying timeout is defined and if no response has been received from a geo-coding knowledge base after the timeout since the geo-coding request was sent, the geo-coding platform 103 stops waiting for the response from the geo-coding knowledge base and considers the response contains zero results.

In step 905, the geo-coding platform 103 determines to transmit the geo-coding request to the one or more go-coding knowledge bases in series. The geo-coding platform 103 causes a querying of the one or more geo-coding knowledge bases in series by transmitting the geo-coding request to the one of the geo-coding knowledge bases at a time. In response, the geo-coding knowledge bases return one or more results one at a time, which the geo-coding platform 103 processes to determine one or more similarity values associated with the one or more results. Thus, by way of example, the geo-coding platform 103 transmits a geo-coding request to one geo-coding knowledge base. If the similarity values of the results of the request from the one geo-coding knowledge base do not satisfy at least one threshold, the geo-coding platform 103 may transmit the geo-coding request to another geo-coding knowledge base before performing subsequent analysis on the geo-coding request.

In step 907, the geo-coding platform 103 determines a prioritized ordering of one or more geo-coding knowledge bases. By way of example, one or more geo-coding knowledge bases may have better results based on, for example, one or more datasets. Further, one or more geo-coding knowledge bases may have restrictions of the number of daily requests. Further, one or more knowledge bases may have other restrictions based on, for example, bandwidth, processing time, processing load, location, accuracy of results, etc. that may be used to prioritize the one or more geo-coding knowledge bases. The weight of a geo-coding knowledge base may be updated based on, for example, the number of queries that are sent to the geo-coding knowledge base that come back with zero or incorrect results. Thus, for example, as the number of zero-result queries increase for a geo-coding knowledge base, the weight for the geo-coding knowledge base may decrease, lowering the priority of the geo-coding knowledge based in the prioritized ordering of the one or more geo-coding knowledge bases.

In step 909, the geo-coding platform 103 determines to transmit the geo-coding request to one or more geo-coding knowledge bases in series based on the prioritized ordering. Thus, for example, after a geo-coding request is generated, the request may be transmitted to a geo-coding knowledge base with the highest priority. If no results are returned, or if the results that are returned do not satisfy a threshold with respect to the similarity value, the geo-coding platform 103 may transmit the request to the geo-coding knowledge base with the second highest priority score, and so forth until a result is obtained that has a similarity value that satisfies a threshold, or until there are no more geo-coding knowledge bases. In one embodiment, if a query of a geo-coding request returns zero results or one or more results that have similarity scores that do not satisfy a threshold, the geo-coding platform 103 may further process the textual query string or the previously created geo-coding request to generate a new geo-coding request that, for example, excludes one or more noise characters and/or words, or excludes one or more flagged characters and/or words. Subsequently, the geo-coding platform 103 may transmit the new geo-coding request to the same, highest priority geo-coding knowledge base to return one or more results. If the one or more results have similarity values that do not satisfy a threshold, or if no results are returned, then the geo-coding platform 103 may transmit the originally created geo-coding request, or any subsequently created geo-coding request, to the next highest priority geo-coding knowledge base. This process may be repeated until there are no more geo-coding knowledge bases to transmit a geo-coding request to.

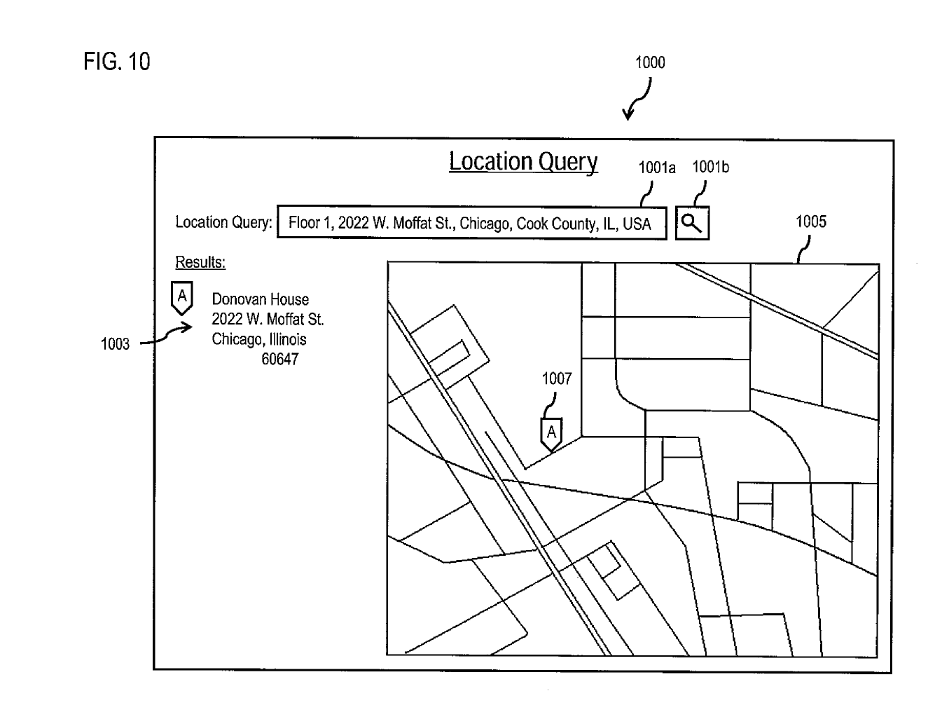

FIG. 10 is a diagram of a user interface 1000 utilized in the processes of FIGS. 3-9, according to an embodiment. The user interface 1000 may be associated with one or more applications 111 (e.g., map application, navigation application, etc.) running on the UE 101. The user interface 1000 may also be associated with a service 109 (e.g., map application, navigation service, etc.) running on the services platform 107. In one embodiment, the user interface 1000 includes a query box 1001a for a user to type in a textual query string that is associated with an address or location for which the user would like to receive geo-coding information. By way of example, the textual query string within the query box 1001a is “Floor 1, 2022 W. Moffat St., Chicago, Cook County, Ill., USA.” The user interface 1000 also includes a search indicator 1001b that, when activated by a user, for example, initiates a request for information associated with geo-coding information associated with the textual query string. At which point, the geo-coding platform 103 receives the request and processes the request according to one or more of the processes discussed above. In response, the geo-coding platform 103 receives one or more results from one or more geo-coding knowledge bases. As illustrated in FIG. 10, the user interface 1000 includes the result 1003. The user interface 1000 also may include a map 1005 to illustrate the location 1007 associated with the result 1003 in response to the request for geo-coding information. As illustrated, the address associated with the result 1003 is slightly different than the textual query string in the query box 1001a. The result 1003 includes Donovan House and the string 1001a includes Floor 1. However, based on the processing of the geo-coding platform 103, the phrases Floor 1 may have been treated as noise words, for example, and removed from the textual query string when generating the geo-coding request. Further, although the result 1003 includes the words Donovan House, the similarity value associated with the results 1003 was determined to be high enough to satisfy a threshold so as to be displayed to the user as a result of the textual query string.

The processes described herein for providing address geo-coding that enhances query result quality while increasing the flexibility of textual query strings may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

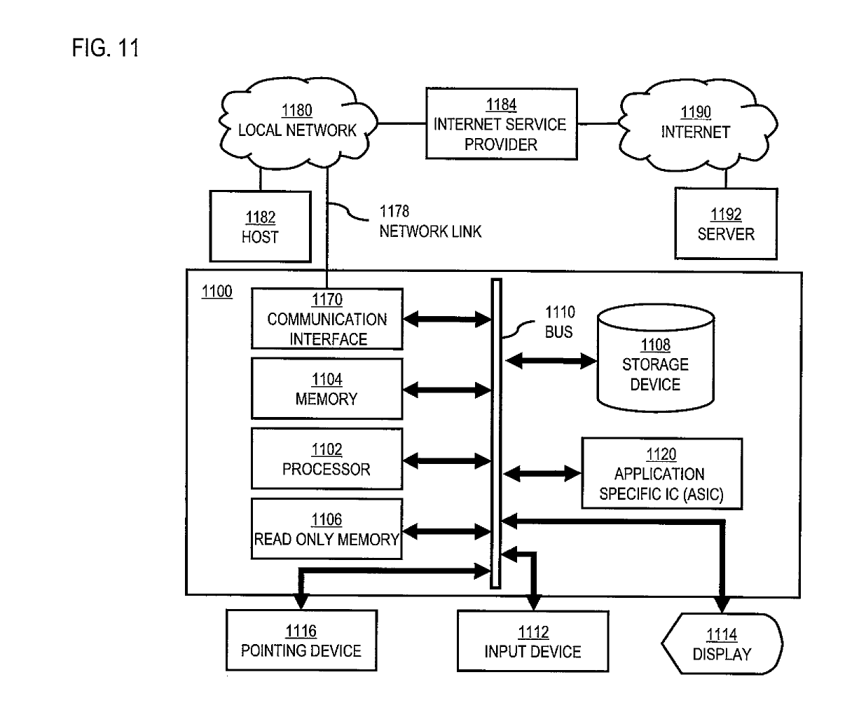

FIG. 11 illustrates a computer system 1100 upon which an embodiment of the invention may be implemented. Although computer system 1100 is depicted with respect to a particular device or equipment, it is contemplated that other devices or equipment (e.g., network elements, servers, etc.) within FIG. 11 can deploy the illustrated hardware and components of system 1100. Computer system 1100 is programmed (e.g., via computer program code or instructions) to provide address geo-coding that enhances query result quality while increasing the flexibility of textual query strings as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1100, or a portion thereof, constitutes a means for performing one or more steps of providing address geo-coding that enhances query result quality while increasing the flexibility of textual query strings.

A bus 1110 includes one or more parallel conductors of information so that information is transferred quickly among devices coupled to the bus 1110. One or more processors 1102 for processing information are coupled with the bus 1110.

A processor (or multiple processors) 1102 performs a set of operations on information as specified by computer program code related to provide address geo-coding that enhances query result quality while increasing the flexibility of textual query strings. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1100 also includes a memory 1104 coupled to bus 1110. The memory 1104, such as a random access memory (RAM) or any other dynamic storage device, stores information including processor instructions for providing address geo-coding that enhances query result quality while increasing the flexibility of textual query strings. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or any other static storage device coupled to the bus 1110 for storing static information, including instructions, that is not changed by the computer system 1100. Some memory is composed of volatile storage that loses the information stored thereon when power is lost. Also coupled to bus 1110 is a non-volatile (persistent) storage device 1108, such as a magnetic disk, optical disk or flash card, for storing information, including instructions, that persists even when the computer system 1100 is turned off or otherwise loses power.

Information, including instructions for providing address geo-coding that enhances query result quality while increasing the flexibility of textual query strings, is provided to the bus 1110 for use by the processor from an external input device 1112, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT), a liquid crystal display (LCD), a light emitting diode (LED) display, an organic LED (OLED) display, a plasma screen, or a printer for presenting text or images, and a pointing device 1116, such as a mouse, a trackball, cursor direction keys, or a motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1120, is coupled to bus 1110. The special purpose hardware is configured to perform operations not performed by processor 1102 quickly enough for special purposes. Examples of ASICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1100 also includes one or more instances of a communication interface 1170 coupled to bus 1110. Communication interface 1170 provides a one-way or two-way communication coupling to a variety of external devices that operate with their own processors, such as printers, scanners and external disks. In general the coupling is with a network link 1178 that is connected to a local network 1180 to which a variety of external devices with their own processors are connected. For example, communication interface 1170 may be a parallel port or a serial port or a universal serial bus (USB) port on a personal computer. In some embodiments, communication interface 1170 is an integrated services digital network (ISDN) card or a digital subscriber line (DSL) card or a telephone modem that provides an information communication connection to a corresponding type of telephone line. In some embodiments, a communication interface 1170 is a cable modem that converts signals on bus 1110 into signals for a communication connection over a coaxial cable or into optical signals for a communication connection over a fiber optic cable. As another example, communication interface 1170 may be a local area network (LAN) card to provide a data communication connection to a compatible LAN, such as Ethernet. Wireless links may also be implemented. For wireless links, the communication interface 1170 sends or receives or both sends and receives electrical, acoustic or electromagnetic signals, including infrared and optical signals, that carry information streams, such as digital data. For example, in wireless handheld devices, such as mobile telephones like cell phones, the communication interface 1170 includes a radio band electromagnetic transmitter and receiver called a radio transceiver. In certain embodiments, the communication interface 1170 enables connection to the communication network 105 for providing enhanced address geo-coding results to the UE 101.

The term “computer-readable medium” as used herein refers to any medium that participates in providing information to processor 1102, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1108. Volatile media include, for example, dynamic memory 1104. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1120.

Network link 1178 typically provides information communication using transmission media through one or more networks to other devices that use or process the information. For example, network link 1178 may provide a connection through local network 1180 to a host computer 1182 or to equipment 1184 operated by an Internet Service Provider (ISP). ISP equipment 1184 in turn provides data communication services through the public, world-wide packet-switching communication network of networks now commonly referred to as the Internet 1190.

A computer called a server host 1192 connected to the Internet hosts a process that provides a service in response to information received over the Internet. For example, server host 1192 hosts a process that provides information representing video data for presentation at display 1114. It is contemplated that the components of system 1100 can be deployed in various configurations within other computer systems, e.g., host 1182 and server 1192.

At least some embodiments of the invention are related to the use of computer system 1100 for implementing some or all of the techniques described herein. According to one embodiment of the invention, those techniques are performed by computer system 1100 in response to processor 1102 executing one or more sequences of one or more processor instructions contained in memory 1104. Such instructions, also called computer instructions, software and program code, may be read into memory 1104 from another computer-readable medium such as storage device 1108 or network link 1178. Execution of the sequences of instructions contained in memory 1104 causes processor 1102 to perform one or more of the method steps described herein. In alternative embodiments, hardware, such as ASIC 1120, may be used in place of or in combination with software to implement the invention. Thus, embodiments of the invention are not limited to any specific combination of hardware and software, unless otherwise explicitly stated herein.

The signals transmitted over network link 1178 and other networks through communication interface 1170, carry information to and from computer system 1100. Computer system 1100 can send and receive information, including program code, through the networks 1180, 1190 among others, through network link 1178 and communication interface 1170. In an example using the Internet 1190, a server host 1192 transmits program code for a particular application, requested by a message sent from computer 1100, through Internet 1190, ISP equipment 1184, local network 1180 and communication interface 1170. The received code may be executed by processor 1102 as it is received, or may be stored in memory 1104 or in storage device 1108 or any other non-volatile storage for later execution, or both. In this manner, computer system 1100 may obtain application program code in the form of signals on a carrier wave.

Various forms of computer readable media may be involved in carrying one or more sequence of instructions or data or both to processor 1102 for execution. For example, instructions and data may initially be carried on a magnetic disk of a remote computer such as host 1182. The remote computer loads the instructions and data into its dynamic memory and sends the instructions and data over a telephone line using a modem. A modem local to the computer system 1100 receives the instructions and data on a telephone line and uses an infra-red transmitter to convert the instructions and data to a signal on an infrared carrier wave serving as the network link 1178. An infrared detector serving as communication interface 1170 receives the instructions and data carried in the infrared signal and places information representing the instructions and data onto bus 1110. Bus 1110 carries the information to memory 1104 from which processor 1102 retrieves and executes the instructions using some of the data sent with the instructions. The instructions and data received in memory 1104 may optionally be stored on storage device 1108, either before or after execution by the processor 1102.

FIG. 12 illustrates a chip set or chip 1200 upon which an embodiment of the invention may be implemented. Chip set 1200 is programmed to provide address geo-coding that enhances query result quality while increasing the flexibility of textual query strings as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1200 can be implemented in a single chip. It is further contemplated that in certain embodiments the chip set or chip 1200 can be implemented as a single “system on a chip.” It is further contemplated that in certain embodiments a separate ASIC would not be used, for example, and that all relevant functions as disclosed herein would be performed by a processor or processors. Chip set or chip 1200, or a portion thereof, constitutes a means for performing one or more steps of providing user interface navigation information associated with the availability of functions. Chip set or chip 1200, or a portion thereof, constitutes a means for performing one or more steps of providing address geo-coding that enhances query result quality while increasing the flexibility of textual query strings.

In one embodiment, the chip set or chip 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1200 includes merely one or more processors and some software and/or firmware supporting and/or relating to and/or for the one or more processors.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to provide address geo-coding that enhances query result quality while increasing the flexibility of textual query strings. The memory 1205 also stores the data associated with or generated by the execution of the inventive steps.

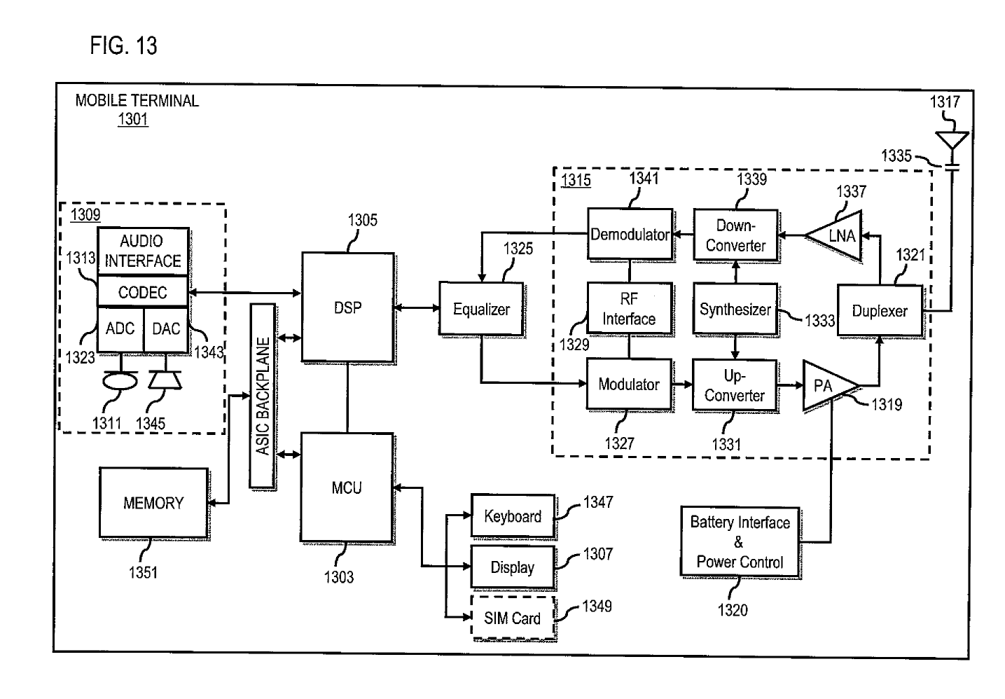

FIG. 13 is a diagram of exemplary components of a mobile terminal (e.g., handset) for communications, which is capable of operating in the system of FIG. 1, according to one embodiment. In some embodiments, mobile terminal 1301, or a portion thereof, constitutes a means for performing one or more steps of providing address geo-coding that enhances query result quality while increasing the flexibility of textual query strings. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1303, a Digital Signal Processor (DSP) 1305, and a receiver/transmitter unit including a microphone gain control unit and a speaker gain control unit. A main display unit 1307 provides a display to the user in support of various applications and mobile terminal functions that perform or support the steps of providing address geo-coding that enhances query result quality while increasing the flexibility of textual query strings. The display 1307 includes display circuitry configured to display at least a portion of a user interface of the mobile terminal (e.g., mobile telephone). Additionally, the display 1307 and display circuitry are configured to facilitate user control of at least some functions of the mobile terminal. An audio function circuitry 1309 includes a microphone 1311 and microphone amplifier that amplifies the speech signal output from the microphone 1311. The amplified speech signal output from the microphone 1311 is fed to a coder/decoder (CODEC) 1313.

A radio section 1315 amplifies power and converts frequency in order to communicate with a base station, which is included in a mobile communication system, via antenna 1317. The power amplifier (PA) 1319 and the transmitter/modulation circuitry are operationally responsive to the MCU 1303, with an output from the PA 1319 coupled to the duplexer 1321 or circulator or antenna switch, as known in the art. The PA 1319 also couples to a battery interface and power control unit 1320.

In use, a user of mobile terminal 1301 speaks into the microphone 1311 and his or her voice along with any detected background noise is converted into an analog voltage. The analog voltage is then converted into a digital signal through the Analog to Digital Converter (ADC) 1323. The control unit 1303 routes the digital signal into the DSP 1305 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1325 for compensation of any frequency-dependent impairments that occur during transmission though the air such as phase and amplitude distortion. After equalizing the bit stream, the modulator 1327 combines the signal with a RF signal generated in the RF interface 1329. The modulator 1327 generates a sine wave by way of frequency or phase modulation. In order to prepare the signal for transmission, an up-converter 1331 combines the sine wave output from the modulator 1327 with another sine wave generated by a synthesizer 1333 to achieve the desired frequency of transmission. The signal is then sent through a PA 1319 to increase the signal to an appropriate power level. In practical systems, the PA 1319 acts as a variable gain amplifier whose gain is controlled by the DSP 1305 from information received from a network base station. The signal is then filtered within the duplexer 1321 and optionally sent to an antenna coupler 1335 to match impedances to provide maximum power transfer. Finally, the signal is transmitted via antenna 1317 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1301 are received via antenna 1317 and immediately amplified by a low noise amplifier (LNA) 1337. A down-converter 1339 lowers the carrier frequency while the demodulator 1341 strips away the RF leaving only a digital bit stream. The signal then goes through the equalizer 1325 and is processed by the DSP 1305. A Digital to Analog Converter (DAC) 1343 converts the signal and the resulting output is transmitted to the user through the speaker 1345, all under control of a Main Control Unit (MCU) 1303 which can be implemented as a Central Processing Unit (CPU).

The MCU 1303 receives various signals including input signals from the keyboard 1347. The keyboard 1347 and/or the MCU 1303 in combination with other user input components (e.g., the microphone 1311) comprise a user interface circuitry for managing user input. The MCU 1303 runs a user interface software to facilitate user control of at least some functions of the mobile terminal 1301 to provide address geo-coding that enhances query result quality while increasing the flexibility of textual query strings. The MCU 1303 also delivers a display command and a switch command to the display 1307 and to the speech output switching controller, respectively. Further, the MCU 1303 exchanges information with the DSP 1305 and can access an optionally incorporated SIM card 1349 and a memory 1351. In addition, the MCU 1303 executes various control functions required of the terminal. The DSP 1305 may, depending upon the implementation, perform any of a variety of conventional digital processing functions on the voice signals. Additionally, DSP 1305 determines the background noise level of the local environment from the signals detected by microphone 1311 and sets the gain of microphone 1311 to a level selected to compensate for the natural tendency of the user of the mobile terminal 1301.

The CODEC 1313 includes the ADC 1323 and DAC 1343. The memory 1351 stores various data including call incoming tone data and is capable of storing other data including music data received via, e.g., the global Internet. The software module could reside in RAM memory, flash memory, registers, or any other form of writable storage medium known in the art. The memory device 1351 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1349 carries, for instance, important information, such as the cellular phone number, the carrier supplying service, subscription details, and security information. The SIM card 1349 serves primarily to identify the mobile terminal 1301 on a radio network. The card 1349 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-53. (canceled)

54. A method comprising facilitating a processing of and/or processing (1) data and/or (2) information and/or (3) at least one signal, the (1) data and/or (2) information and/or (3) at least one signal based, at least in part, on the following:
a request for geo-coding information, wherein the request is from a client to at least one geo-coding knowledge base and specifies at least one textual input;
a generation of at least one geo-coding request based, at least in part, on the at least one textual input; and
at least one determination to transmit the at least one geo-coding request to the at least one geo-coding knowledge base, one or more other geo-coding knowledge bases, or a combination thereof.

55. A method of claim 54, wherein the (1) data and/or (2) information and/or (3) at least one signal are further based, at least in part, on the following:
one or more characters, one or more words, or a combination thereof within the at least one textual input that are associated with one or more synonyms; and
a replacement of the one or more characters, the one or more words, or the combination thereof with the one or more synonyms to generate, at least in part, the at least one geo-coding request.

56. A method of claim 54, wherein the (1) data and/or (2) information and/or (3) at least one signal are further based, at least in part, on the following:
the generation of the at least one geo-coding request based, at least in part, on removing one or more characters, one or more words, or a combination thereof from the at least one textual input.

57. A method of claim 54, wherein the (1) data and/or (2) information and/or (3) at least one signal are further based, at least in part, on the following:
determining one or more noise characters, one or more noise words, or a combination thereof based, at least in part, on a comparison of one or more characters, one or more words, or a combination thereof associated with the at least one textual input to one or more noise-word lists; and
a removal of the one or more noise characters, the one or more noise words, or the combination thereof from the at least one textual input to generate, at least in part, the at least one geo-coding request.

58. A method of claim 54, wherein the (1) data and/or (2) information and/or (3) at least one signal are further based, at least in part, on the following:
one or more flagged characters, one or more flagged words, or a combination thereof based, at least in part, on a comparison of one or more characters, one or more words, or a combination thereof associated with the at least one textual input to one or more flagged-word lists; and
a removal of the one or more flagged characters, the one or more flagged words, or the combination thereof from the at least one textual input to generate, at least in part, the at least one geo-coding request.

59. A method of claim 54, wherein the (1) data and/or (2) information and/or (3) at least one signal are further based, at least in part, on the following:
a processing of one or more results with respect to the at least one geo-coding request to determine one or more similarity values associated with the one or more results; and
at least one determination whether a highest similarity value satisfies at least one threshold.

60. A method of claim 59, wherein the (1) data and/or (2) information and/or (3) at least one signal are further based, at least in part, on the following:
a processing of the one or more results, the at least one geo-coding request, the at least one textual input, or a combination thereof to generate one or more word vectors; and
at least one determination of the one or more similarity values based, at least in part, on a word weighting, an original query weighting, or a combination thereof associated with the one or more word vectors.

61. A method of claim 60, wherein the (1) data and/or (2) information and/or (3) at least one signal are further based, at least in part, on the following:
a comparison of one or more words of the one or more word vectors to an ignore-word list, a low-weight word list, or a combination thereof;
a significance weight of the one or more words based, at least in part, on an order of the one or more words in the one or more word vectors; and
at least one determination of a word weight based, at least in part, on the comparison, the significance weight, or a combination thereof.

62. A method of claim 59, wherein the (1) data and/or (2) information and/or (3) at least one signal are further based, at least in part, on the following:
a generation of at least one subsequent geo-coding request based, at least in part, on the at least one textual input, the at least one geo-coding request, or a combination thereof if the highest similarity value does not satisfy the at least one threshold;
a processing of one or more subsequent results with respect to the at least one textual input, the at least one subsequent geo-coding request, or a combination thereof to determine one or more subsequent similarity values associated with the one or more subsequent results; and
determining whether the highest subsequent similarity value associated with any of the one or more subsequent results satisfies the at least one threshold.

63. A method of claim 59, wherein the (1) data and/or (2) information and/or (3) at least one signal are further based, at least in part, on the following:
at least one determination to generate the one or more results based, at least in part, on a querying of the at least one geo-coding request at the at least one geo-coding knowledge base, the one or more geo-coding knowledge bases, or the combination thereof.

64. An apparatus comprising:
at least one processor; and
at least one memory including computer program code for one or more programs,
the at least one memory and the computer program code configured to, with the at least one processor, cause the apparatus to perform at least the following,
determine a request for geo-coding information, wherein the request is from a client to at least one geo-coding knowledge base and specifies at least one textual input;
cause, at least in part, a generation of at least one geo-coding request based, at least in part, on the at least one textual input; and
determine to transmit the at least one geo-coding request to the at least one geo-coding knowledge base, one or more other geo-coding knowledge bases, or a combination thereof.

65. An apparatus of claim 64, wherein the apparatus is further caused to:
determine one or more characters, one or more words, or a combination thereof within the at least one textual input that are associated with one or more synonyms; and
cause, at least in part, a replacement of the one or more characters, the one or more words, or the combination thereof with the one or more synonyms to generate, at least in part, the at least one geo-coding request.

66. An apparatus of claim 64, wherein the apparatus is further caused to:
cause, at least in part, the generation of the at least one geo-coding request based, at least in part, on removing one or more characters, one or more words, or a combination thereof from the at least one textual input.

67. An apparatus of claim 64, wherein the apparatus is further caused to:
determine one or more noise characters, one or more noise words, or a combination thereof based, at least in part, on a comparison of one or more characters, one or more words, or a combination thereof associated with the at least one textual input to one or more noise-word lists; and
cause, at least in part, a removal of the one or more noise characters, the one or more noise words, or the combination thereof from the at least one textual input to generate, at least in part, the at least one geo-coding request.

68. An apparatus of claim 64, wherein the apparatus is further caused to:
determine one or more flagged characters, one or more flagged words, or a combination thereof based, at least in part, on a comparison of one or more characters, one or more words, or a combination thereof associated with the at least one textual input to one or more flagged-word lists; and
cause, at least in part, a removal of the one or more flagged characters, the one or more flagged words, or the combination thereof from the at least one textual input to generate, at least in part, the at least one geo-coding request.

69. An apparatus of claim 64, wherein the apparatus is further caused to:
process and/or facilitate a processing of one or more results with respect to the at least one geo-coding request to determine one or more similarity values associated with the one or more results; and
determine whether a highest similarity value satisfies at least one threshold.

70. An apparatus of claim 69, wherein the apparatus is further caused to:
process and/or facilitate a processing of the one or more results, the at least one geo-coding request, the at least one textual input, or a combination thereof to generate one or more word vectors; and
determine the one or more similarity values based, at least in part, on a word weighting, an original query weighting, or a combination thereof associated with the one or more word vectors.

71. An apparatus of claim 70, wherein the apparatus is further caused to:
cause, at least in part, a comparison of one or more words of the one or more word vectors to an ignore-word list, a low-weight word list, or a combination thereof;
determine a significance weight of the one or more words based, at least in part, on an order of the one or more words in the one or more word vectors; and
determine the word weight based, at least in part, on the comparison, the significance weight, or a combination thereof.

72. An apparatus of claims 69, wherein the apparatus is further caused to:
cause, at least in part, a generation of at least one subsequent geo-coding request based, at least in part, on the at least one textual input, the at least one geo-coding request, or a combination thereof if the highest similarity value does not satisfy the at least one threshold;
process and/or facilitate a processing of one or more subsequent results with respect to the at least one textual input, the at least one subsequent geo-coding request, or a combination thereof to determine one or more subsequent similarity values associated with the one or more subsequent results; and
determine whether the highest subsequent similarity value associated with any of the one or more subsequent results satisfies the at least one threshold.

73. An apparatus of claim 69, wherein the apparatus is further caused to:
determining to generate the one or more results based, at least in part, on a querying of the at least one geo-coding request at the at least one geo-coding knowledge base, the one or more geo-coding knowledge bases, or the combination thereof.
